(19) United States
(12) Patent Application Publication
(10) Pub. No.: US 2023/0401349 A1
(43) Pub. Date: Dec. 14, 2023

(54) PARAMETER BASED CONSTRUCTION

(71) Applicant: PT Blink Limited, Sydney, New South Wales (AU)

(72) Inventor: Murray Edington ELLEN, Lindfield, New South Wales (AU)

(21) Appl. No.: 18/251,118

(22) PCT Filed: Oct. 29, 2021
(86) PCT No.: PCT/AU2021/051269

§ 371 Date: Apr. 28, 2023

(30) Foreign Application Priority Data
Oct. 29, 2020 (AU) 2020903921

(51) Int. Cl. G06F 30/13; G06Q 50/08

(52) U.S. Cl. CPC G06F 30/13; G06Q 50/08; G06F 2111/04

(57) ABSTRACT

A computer implemented method (900) of constructing a building (124) comprising receiving (903) an input specification (104) specifying pre-harmonisation modules (129′, 127′, 141′) required to construct the building, said modules defined by pre-harmonisation module specifications (103, 102, 101, 147) comprising respective geometric parameters (1001, 1102, 1201) and respective attributes (1002, 1102, 1202); identifying (905) which of the pre-harmonisation module specifications are stored in a database (110), said identified pre-harmonisation module specifications having associated geometric parameters and attributes which are stored in separate sections of the database; harmonising (300, 400, 500, 600) the module specifications in the first pre-harmonisation module specifications to form a set (120) of harmonised module specifications (129, 127, 141) which specify harmonised modules which (a) substantially do not clash when they are used to construct the building (124), and (b) when assembled to form the building (124) satisfy attribute criteria specified in the input specification (104); and constructing (911) the building (124) using the harmonised module specification (120).

### TECHNICAL FIELD

The present invention relates generally to the field of building construction and, in particular, to improving the efficiency in construction of buildings, ranging from relatively low complexity single storey buildings to high-rise skyscrapers. The present invention also relates to a method and apparatus for improving the efficiency in construction of buildings, and to a computer program product including a computer readable medium having recorded thereon a computer program for improving the efficiency in construction of buildings.

### BACKGROUND

A plethora of Building Information Modelling (BIM) software is presently available to assist architecture, engineering, and construction (AEC) professionals to plan, design, and construct buildings and infrastructure. However, present building construction methods still require significant adjustment on-site to make building modules fit and meet required specifications.

### SUMMARY

It is an object of the present invention to substantially overcome, or at least ameliorate, one or more disadvantages of existing arrangements.

Disclosed are arrangements, referred to as a Harmonised Parameter based Design for Manufacture and Assembly (HPDMI) arrangement, which seek to address the above problems by providing a cloud-based platform enabling participants across the construction space, from architects, through participants in all the requisite trades, building certifiers and the like to (A) access and populate an electronically accessible construction catalogue storing a hierarchical collection of parts, assemblies, master-assemblies and the like, which can be used as standardised elements in construction, (B) access industry approved 3^{rd} party software platforms used to create, analyse and process such standardised elements, and (C) harmonise elements generated for and selected from the catalogue for a particular construction project to ensure that the generated and selected elements (i) substantially do not clash when they are used to construct the building, and (ii) when assembled to form the building satisfy attribute criteria specified in the input specification. In other words, the disclosed HPDMI arrangements enable building modules to be manufactured off-site and assembled on-site to form the desired building with significantly less on-site adjustment being required to make the building modules fit and meet specified attributes than is the case with present building construction methods.

According to a first aspect of the present disclosure, there is provided a computer implemented method of constructing a building, the method comprising the steps of:
receiving an input specification for the building, said input specification specifying pre-harmonisation modules required to construct the building, said pre-harmonisation modules defined by respective pre-harmonisation module specifications comprising respective geometric parameters and respective attributes;
identifying which of the pre-harmonisation module specifications are stored in an electronically accessible database, said identified pre-harmonisation module specifications being referred to as first pre-harmonisation module specifications having associated geometric parameters and attributes which are stored in separate sections of the database;
harmonising the module specifications in the first pre-harmonisation module specifications to form a set of harmonised module specifications which specify harmonised modules which (a) substantially do not clash when they are used to construct the building, and (b) when assembled to form the building satisfy attribute criteria specified in the input specification; and
constructing the building using the harmonised module specification.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects are also disclosed.

### BRIEF DESCRIPTION OF THE DRAWINGS

Preferred embodiments of the present invention will now be described, by way of example only, with reference to the drawings, in which:

FIG. 1 shows a functional block diagram for one example of the disclosed HPDMI arrangement;

FIGS. 2A and 2B form a schematic block diagram of a general-purpose computer system upon which HPDMI arrangements described can be practiced;

FIG. 3 is an example flow chart for apart-based HPDMI harmonisation process;

FIG. 4 is an example flow chart for an assembly-based HPDMI harmonisation process;

FIG. 5 is an example flow chart for a master-assembly-based HPDMI harmonisation process;

FIG. 6 shows an example flow chart for an HPDMI geometric parameter and attribute harmonisation process used in the processes of FIGS. 3, 4 and 5;

FIG. 7 shows a flow chart for an example process for performing the HPDMI process using the processes of FIGS. 3, 4 and 5;

FIG. 8 illustrates a simplified HPDMI example in which the harmonisation process is applied to geometric parameters only for ease of description;

FIG. 9 is a flow chart of an example process for performing the HPDMI process;

FIG. 10 shows an example 1000 of a part-based segment of the database 110;

FIG. 11 shows an example 1100 of an assembly-based segment of the database 110;

FIG. 12 shows an example 1200 of a master-assembly-based segment of the database 110;

FIG. 13 shows a generic representation of a building 1300 formed from an array of parts;

FIG. 14 shows an example flow chart for a part-based HPDMI harmonisation process according to another preferred embodiment;

FIGS. 15A to 15E show an example of the process of FIG. 14;

FIG. 16 shows an example flow chart for an assembly-based HPDMI harmonisation process according to the preferred embodiment of FIG. 14;

FIGS. 17A & 17B show an assembly created with the process of FIG. 16;

FIG. 18 shows an example flow chart for a project-based HPDMI harmonisation process according to the preferred embodiment of FIG. 14;

FIG. 19 shows an illustrative example of the harmonisation of the HPDI harmonisation process of the preferred embodiment of FIG. 14; and

FIG. 20 shows an example of construction of the parametric catalogue using the HDPMI harmonisation process in the preferred embodiment of FIG. 14.

APPENDIX A shows examples of 3^{rd} party software applications which can be used in the disclosed HPDMI arrangements when used for constructing a building.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and the section above relating to prior art arrangements relate to discussions of documents or devices which may form public knowledge through their respective publication and/or use. Such discussions should not be interpreted as a representation by the present inventor(s) or the patent applicant that such documents or devices in any way form part of the common general knowledge in the art.

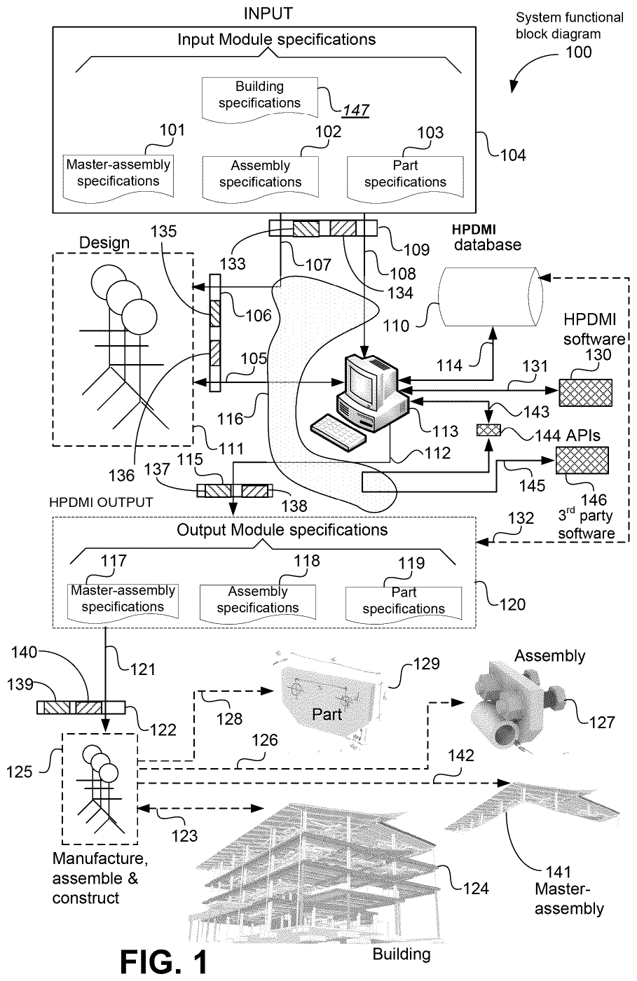

FIG. 1 shows a functional block diagram 100 for one example of the disclosed HPDMI arrangement. In use, in one example one or more architects (not shown) who have been commissioned to design the building 124 create an input specification 104 which specifies the building using one or more of (A) a specification 147 for the building, (B) specifications 103 for parts, (C) specifications 102 for assemblies, (D) and specifications 101 for master-assemblies.

Thus, for example, the architect may provide an input specification 104 for the building 124 (which is a school in this example) in the form of a building specification 147 comprising drawings or more likely a 3D model of a complete school. The building specification 147 may have broad geometry specifications such as the length of the building, the offset from a boundary, and the height of the building.

Alternately, the input specification 104 may be provided by the architect at the master-assembly level, and thus in this example may comprise drawings of each complete classroom, these being master-assembly specifications 101.

Accordingly, the described HPDMI arrangements enable the input specification 104 for the building to be provided by the architect at any one or more of four levels in the described arrangements. Clearly however depending upon the scale of the building 124 a different number of hierarchical levels can be used.

The described HPDMI arrangements iteratively combine/decompose and parametrise the specific combination of building specifications 147, master-assembly specifications 101, assembly specifications 102 and part specifications to produce parametrised parts at the atomic level. The parametric geometric parameters and attributes of specifications at each of the relevant levels are stored in an HPDMI database 110 for later use. This is to enable, for example, the specifications in the database to be used to recreate the same school or a different building using the specifications in the database as building blocks, as described hereinafter in more detail with reference to FIG. 1 below.

As described hereinafter in more detail below the specifications 147, 103, 102 and 101 respectively specify parts, assemblies and master-assemblies to a preliminary degree of precision which is typically not yet suitable for manufacture, assembly and construction of the building 124. The specifications 103 for the parts, the specifications 102 for the assemblies, and the specifications 101 for the master-assemblies in the input specification 104 are referred to as pre-harmonisation module specifications.

In order to ensure that the specifications for the parts, the specifications for the assemblies, and the specifications for the master-assemblies have the required degree of precision which is suitable for manufacture, assembly and construction of the building 124, one or more designers 111 process the input specification 104 containing the pre-harmonisation specifications 103 for the parts, the pre-harmonisation specifications 102 for the assemblies, and the pre-harmonisation specifications 101 for the master-assemblies using the disclosed HPDMI system 100 to create an output specification which specifies specifications 119 for parts, specifications 118 for assemblies, and specifications 117 for master-assemblies with the required degree of precision which is suitable for manufacture, assembly and construction of the building 124. The specifications 119 for the parts, the specifications 118 for the assemblies, and the specifications 117 for the master-assemblies in the output module specification 120 are referred to as harmonised module specifications. This process is further detailed with reference to FIG. 6 below setting out the geometric parameter and attribute harmonisation.

The terms “assemble” and “construct” are used interchangeably in this specification unless the contrary intention is expressed. Although this description describes an HPDMI arrangement example in the context of constructing the building 124, the HPDMI arrangement can be used to construct a broader range of items.

As described above the described HPDMI arrangements use a hierarchical arrangement of modules referred to as parts, assemblies and master-assemblies. An example of a part is the part 129 which is a plate with holes. An example of an assembly is the assembly 127 which is made up of the plate 129, two fasteners and a section of tube. An example of a master-assembly is the master assembly 141 which is a complete roof section as can be seen in the building 124. The building 124 is constructed from harmonised parts such as 129, harmonised assemblies such as 127, and harmonised master-assemblies such as 141.

The input specification 104 is made up of module specifications including part specifications 103 and/or assembly specifications 102 and/or master-assembly specifications 101. An example of a part specification is a specification for a part 129 in FIG. 1. An example of an assembly specification is a specification for an assembly 127 in FIG. 1. An example of a master-assembly specification is a specification for a master-assembly 141 in FIG. 1. The building 124 in question may be constructed using one or more of the part specifications 103, the assembly specifications 102, and the master assembly specifications 101.

An important element in the disclosed HPDMI arrangements is a “living” electronically accessible HPDMI database or catalogue 110, which continuously accumulates specifications for parts, assemblies and master-assemblies for future use. Although not illustrated, it will be appreciated that the catalogue 110 can be formed from harmonised parts 103, assemblies 102 and master-assemblies 101, for example, each element of the catalogue can be stored in a digital blockchain ledger such as Ethereum. In this way, each catalogued component is stored in a blockchain address that is validated at creation and is able to be transferred in accordance with conventional non-fungible tokens. In this way, catalogue 110 entries can be used, copied or transferred and their authenticity of data is transparently verifiable. For example, an NFT tokenised catalogue 110 or entry therein can be allowed to be used under license or even owned. Since the data of the catalogue NFTs is verifiable, it prevents or minimises any modification of the catalogue or entries that would not be in conformity with the requirements providing a level of certainty and safety.

It will be understood that by executing the catalogue or entries thereof as part of a verifiable digital ledger that parts or assemblies can be procured, for example, which can then be associated with assembly and payments can be assigned to correspond with those procured elements. In the example of a window described illustratively with respect to FIG. 6, it will be appreciated that for a building having a plurality of windows that each one can be individually verified from design, to manufacture to integration. This allows for payment, for example, of each window in a building to be paid for upon individual receipt or installation rather than as part of every window. When executed in a smart contract, ownership of say each window can be transferred once they have been paid for. This can assist not only with assuring catalogue entries are unmodified but also building project financing as the NFTs are able to be transferred.

The building 124 may be constructed using only parts such as 129 or may be constructed using only assemblies such as 127 or may be constructed using only master-assemblies such as 141. Typically, however, the building 124 is constructed using some parts, as specified by the parts specifications 103, some assemblies, as specified by the assembly specifications 102, and some master-assemblies, as specified by the master-assembly specifications 101.

Since the new building 124 is typically a new combination of parts, assemblies and master-assemblies, typically combined in a new way, it is likely that parts, assemblies and master-assemblies whose specifications are drawn from the catalogue 110 will clash to some extent when assembled to form the building 124. This means that, dependent upon their respective geometric parameters, some parts, assemblies and master-assemblies will, when assembled, partly occupy the same space as other parts, assemblies and master-assemblies. It is also likely that the attributes of the building 124, as determined by the composite attributes of the parts, assemblies and master-assemblies whose specifications are drawn from the database 110 and used to construct the building 124, will not satisfy the attributes for the building 124 as specified in the input specification 104. This is because while the attributes of the parts, assemblies and master-assemblies whose specifications are in the catalogue 110 may be close to those required by the input specification 104, they will likely not match the requirements of the specification 104 precisely.

Upon receipt of the input specification 104 the designers 111 use the HPDMI arrangement to select those module specifications (referred to as first pre-harmonised module specifications) from the catalogue 110 which match the input module specifications 101, 102 and 103 in the input specification 104. As the database 110 becomes more populated with module specifications over time the designers will likely more often than not find all the required module specifications in the database 111. However, if not all the required module specifications in the input specification 104 are found in the database 111 the designers can use the HPDMI system 110, and appropriate 3^{rd} party software applications 146, to generate new module specifications for desired specifications which are not present in the catalogue 110, these desired specifications being referred to as second pre-harmonised module specifications.

The HPDMI system then enables the designers 111 to harmonise the set of pre-harmonised module specifications comprising the first and second pre-harmonised module specifications, using the 3^{rd} party software applications 146 where necessary. The harmonisation process produces the harmonised part, assembly and master-assembly specifications 119, 118 and 117 respectively whose corresponding parts, assemblies and master-assemblies, when used to construct the building 124, will substantially not clash and will substantially meet the attribute requirements set by the input specification 104.

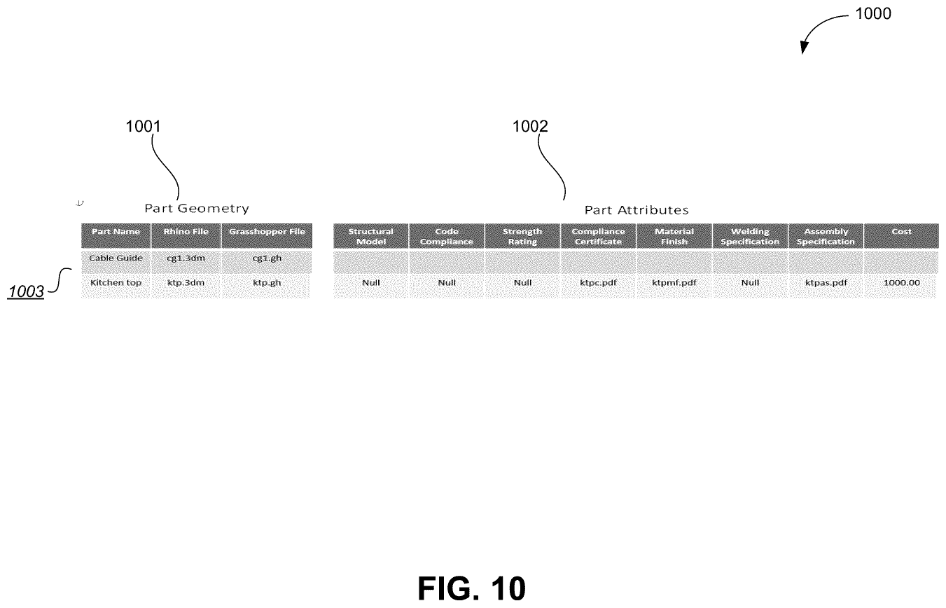

The construction of the building 124 is performed using largely pre-manufactured modules such as parts 129, assemblies 127, and master assemblies 141, some of which have respective pre-harmonisation part specifications 103, pre-harmonisation assembly specifications 102 and pre-harmonisation master-assembly specifications 101 stored in the electronically accessible HPDMI database 110 (also referred to as a catalogue). The pre-harmonisation specifications, described hereinafter in more detail with reference to FIGS. 10-12, include geometric parameters 1001 and attributes 1002.

An example geometric parameter associated with a pre-harmonisation part specification for a part 129′ (which is a pre-harmonised version of the part 129) is a thickness of the plate used in the part in mm. An example attribute associated with the pre-harmonisation part specification for the part 129′ is the Youngs modulus in N/m² of the plate.

An example geometric parameter associated with a pre-harmonisation assembly specification for an assembly 127′ (which is a pre-harmonised version of the assembly 127) is a thickness of the tube walls. An example attribute associated with the pre-harmonisation assembly specification for the assembly 127′ is the shear stress that the assembly 127′ can tolerate.

An example geometric parameter associated with a pre-harmonisation master-assembly specification for a master-assembly 141′ (which is a pre-harmonised version of the master-assembly 141) is a slope of the roof. An example attribute associated with the pre-harmonisation master-assembly specification for the master-assembly 141′ is the wind load that the master-assembly 141′ can tolerate.

Although mechanical attributes have been provided above as examples, clearly other attributes can be encompassed by the disclosed HPDMI arrangements including electrical attributes (e.g. resistivity), hydraulic attributes (e.g. Reynolds number), code attributes (e.g. compliance with specific standards), and the like.

In the example of FIG. 1 the harmonised parts such as 129, the harmonised assemblies such as 127, and the harmonised master-assemblies such as 141 can be effectively designed and manufactured off-site. The ingenuity of the disclosed HPDMI arrangement is that during the design and the manufacture, the parts, the assemblies and the master-assemblies are harmonised, by harmonising their respective part specifications, assembly specifications and master-assembly specifications in the context of the output specification 120 of the building 124. As a result of the harmonisation, when the harmonised parts such as 129, the harmonised assemblies 127, and the harmonised master assemblies 141 (respectively associated with the harmonised part specifications 119, the harmonised assembly specifications 118 and the harmonised master-assembly specifications 117 in the output specification 120) are assembled on-site in order to construct the building 124 the following is achieved: (a) the harmonised parts, the harmonised assemblies and the harmonised master-assemblies all fit together geometrically to a very high degree of “fit” (i.e. there are substantially no “clashes”), and (b) the building 124, the constituent harmonised parts and the harmonised assemblies and the harmonised master-assemblies satisfy criteria defined by attributes associated with the building 124, the master-assemblies such as 141, the assemblies such as 127, and the parts such as 129.

In use the design team 111 receives the input specification 104, which has been produced by the architect (not shown), over a communication network 116, the aforementioned communication taking place between a remote terminal 109 used by the architect and a remote terminal 106 used by the design team 111 as depicted by an arrow 107. The architect can also communicate the input specification 104 to a server 113 over the network 116 as depicted by an arrow 108. The design team 111 communicates with the server 113 over the network 116 as depicted by an arrow 105. The server 113 executes an HPDMI software application 130 which enables the design team 111 to search the HPDMI catalogue 110 for pre-defined pre-harmonisation parts, pre-harmonisation assemblies, and pre-harmonisation master-assemblies which have a preliminary match to requirements of the input specification 104, as depicted by an arrow 114.

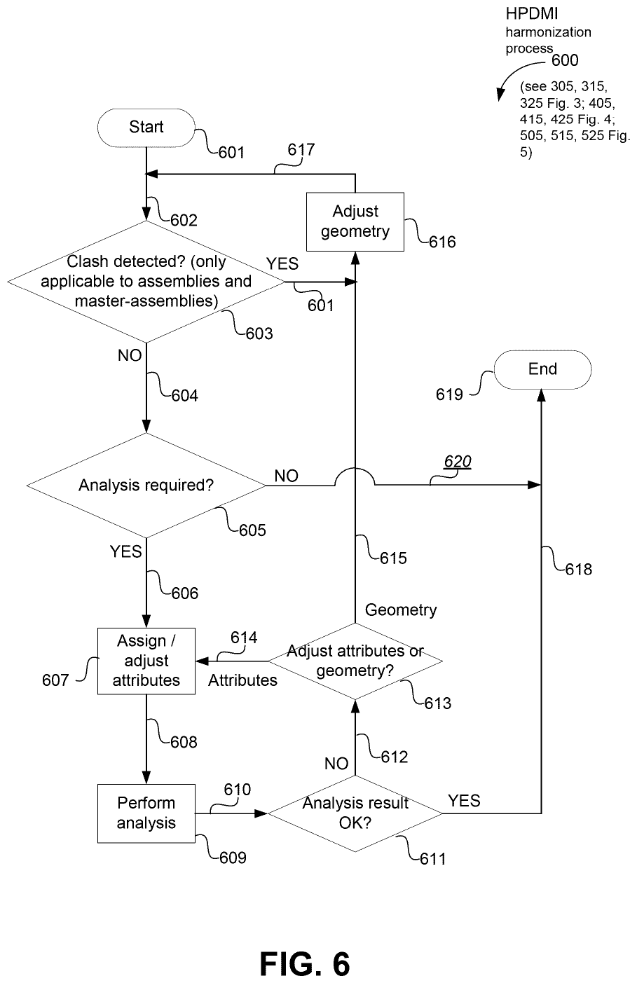

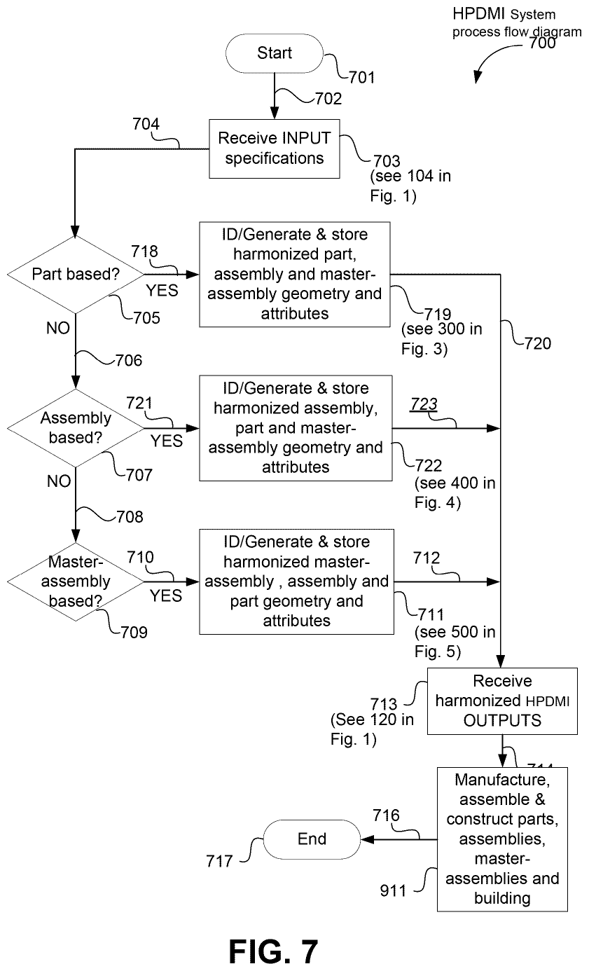

The server 113 executing the HPDMI software application 130 also enables the design team 111 to access 3^{rd} party software applications such as Rhinoceros 3D 146, via one or more Application Programming Interfaces (APIs) 144, as depicted by arrows 143, 145, in order to (a) create pre-harmonisation parts, pre-harmonisation assemblies and pre-harmonised master-assemblies which are not pre-defined and stored in the HPDMI catalogue 110 (for example see the part 808 in FIG. 8), and (b) store these in the HPDMI catalogue 110, as depicted by the arrow 114.

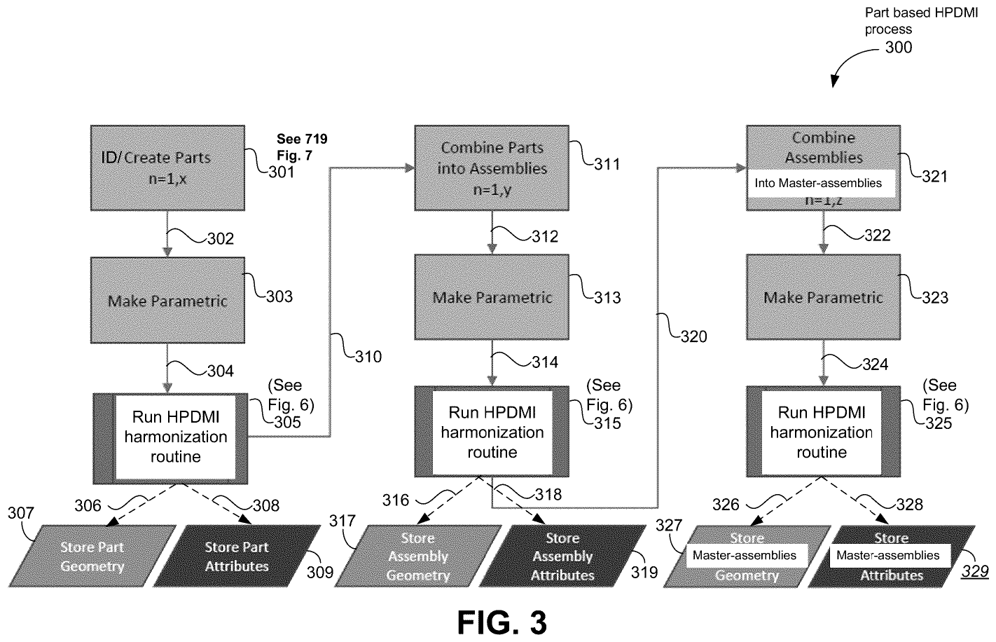

The server 113 executing the HPDMI software application 130 also enables the design team 111 to harmonise the pre-harmonisation part specifications 103, the pre-harmonisation assembly specifications 102 and the pre-harmonisation master-assembly specifications 101 in the input specification 104, whether these are found in the HPDMI database 110 or created by the design team 111, as required to construct the building 124, as described hereinafter in regard to FIGS. 3-9.

The server 113 executing the HPDMI software application 130 also communicates the harmonised HPDMI output specification 120 over the communication network 116 to a manufacture, assemble and construction team 125 via one or more remote terminals 122, as depicted by arrows 112, 121. The manufacture, assemble and construction team 125 uses the harmonised HPDMI output specification 120 to manufacture, assemble and construct the building 124 (as depicted by a dashed arrow 123) using harmonised parts such as 129 (as depicted by a dashed arrow 128), harmonised assemblies such as 127 (as depicted by a dashed arrow 126), and harmonised master-assemblies such as 141 (as depicted by a dashed arrow 142).

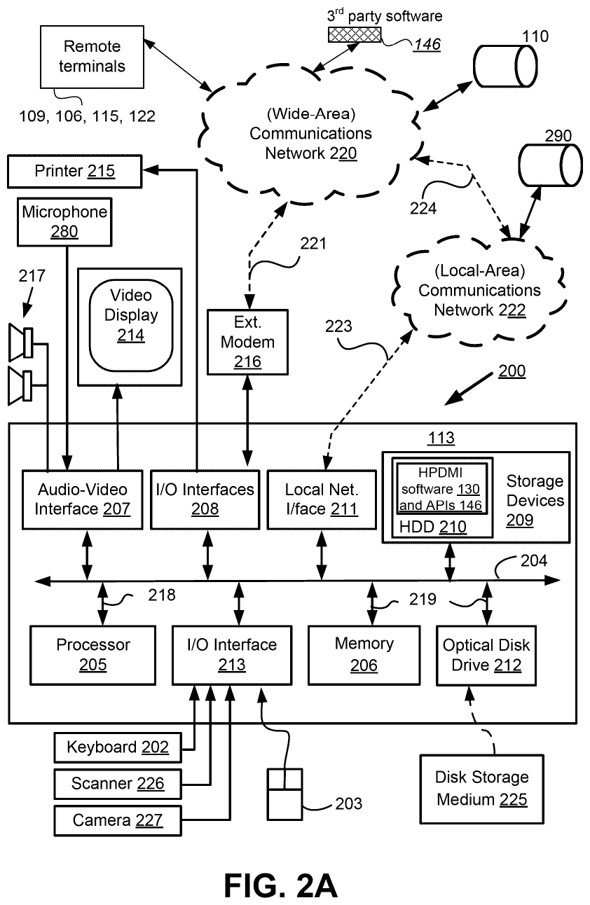

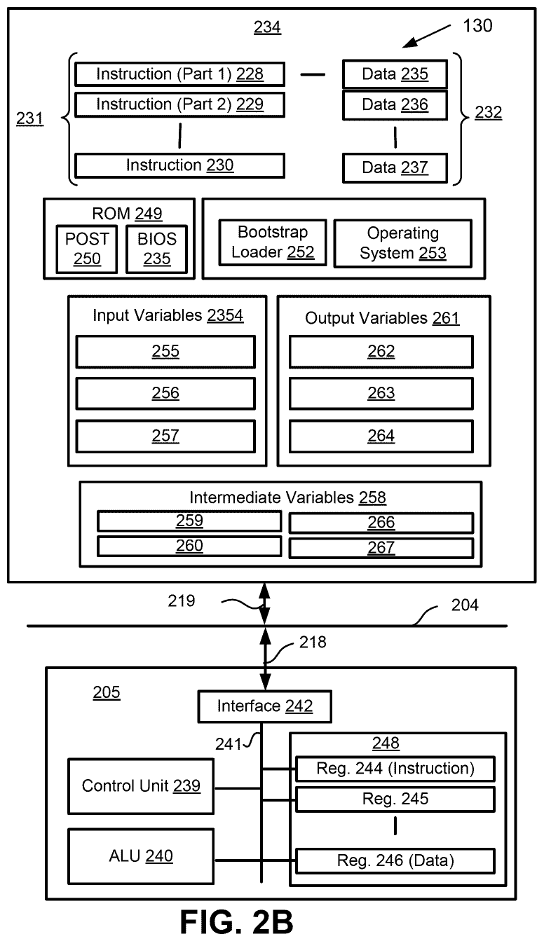

Turning to the structural details of the system 100 the server 113, described hereinafter in more detail with respect to FIGS. 2A and 2B, contains a computer processor 205 and the computer executable HPDMI software program 130. The server 113 communicates with the HPDMI catalogue 110 as depicted by the arrow 114. The catalogue (database) 110 can be locally located with the server 113 or can be located remotely in which case the server 113 communicates with the catalogue 110 over the communication network 116. Both the server 113 and the catalogue 110 can be implemented in centralised form as shown in FIG. 1, or in distributed form in which a number of distinct spatially distributed server computers (not shown) interwork to perform the server function, and a number of distinct spatially distributed databases (not shown) interwork to perform the catalogue function.

The server 113 communicates over the communication network 116 with the one or more 3^{rd} party software applications 146 running on remote servers (not shown) via corresponding APIs 144 as depicted by arrows 143 and 145. The particular 3^{rd} party software applications which may be used depend upon the specific purpose for which the HPDMI system is used. In the example of constructing the building 124, one or more 3^{rd} party software applications used in the building trade are used. Examples of such 3^{rd} party software applications used in the building trade are set out in APPENDIX A. These include software applications associated with disciplines such as mechanical engineering, electrical engineering and so on.

The server communicates over the communication network 116 as depicted by an arrow 108 with the remote terminal 109 which contains a computer processor 133 which executes a computer executable software program (not shown) stored in a non-transitory tangible memory module 134. The software program executed by the processor 133 can interwork with the software program 130 executed by the processor 205 in the server 113 and with software programs executing in the other remote terminals 106 and 122. The remote terminal 109 facilitates communication of the input specification 104 to the server 113.

The input specification 104 which has been created by the architect designing the building 124 is used for constructing the building 124 according to the disclosed HPDMI arrangement. The input specification 104 comprises, in the example shown, a number of input module specifications including a pre-harmonisation part specification 103 which specifies the pre-harmonised parts to be used in constructing the building 124, a pre-harmonisation assembly specification 102 which specifies the pre-harmonised assemblies to be used in constructing the building 124, and a pre-harmonisation master assembly specification 101 which specifies the pre-harmonised master assemblies to be used in constructing the building 124.

The server 113 also communicates over the network 116, as depicted by the arrow 105, with the remote terminal 106. The remote terminal 106 contains a computer processor 135 which executes a computer executable software program (not shown) stored in a non-transitory tangible memory device 136. The remote terminal 106 enables the design team 111 to communicate with the server 113, as depicted by the arrow 105, in order to use the disclosed HPDMI arrangement.

The server 113 also outputs, as depicted by an arrow 112, the harmonised HPDMI output 120. The harmonised HPDMI output 120 comprises a set of harmonised output module specifications, namely a harmonised part specification 119 which specifies the harmonised parts to be used in constructing the building 124, a harmonised assembly specification 118 which specifies the harmonised assemblies to be used in constructing the building 124, and a harmonised master assembly specification 117 which specifies the harmonised master assemblies to be used in constructing the building 124.

The output specification 120 is communicated, as depicted by an arrow 121, to one or more remote terminals 122 which contain computer processors 139 which execute computer executable software programs (not shown) stored in non-transitory tangible memory devices 140. The remote terminal(s) 122 enables the manufacture, assemble and construct team 125 to obtain the necessary information from the output specification 120 to enable design, manufacture and assembly of harmonised parts such as 129, harmonised assemblies such as 127, and harmonised master assemblies such as 141 to form the building 124.

FIG. 8 illustrates a simplified HPDMI example 800 in which the harmonisation process is applied to geometric parameters only for ease of description and it will be appreciated harmonisation for the parts, assemblies and master-assemblies is provided. In the depicted example a number of parts specified by the architect are to be assembled into an assembly specified by the architect. In practice harmonisation is performed on part, assembly and master-assembly specifications which when manufactured result in harmonised parts, harmonised assemblies and harmonised master assemblies. In the following description of FIG. 8 harmonisation is described as being performed on the parts and assemblies themselves (rather than on their specifications) for ease of description.

A depiction of a 1^{st} instance of the catalogue 110 is shown at 812. This catalogue instance contains three pre-harmonised parts 801, 802 and 803. It is desired to construct an assembly depicted by a dotted ellipse 814, specified by the architect, which is shown in a 2^{nd} instance of the catalogue 813. From 814 it is seen that the desired assembly specified by the architect (see the input specification 104 in FIG. 1) is made up of three modules namely (a) a part 801′ which is a harmonised (suitably scaled-up) version of the pre-harmonised part 801, (b) a part 808 which is not present in the database instance 812 and is newly created in the database instance 813, and (c) a part 803′ which is a harmonised (suitably scaled-down) version of the pre-harmonised part 803 in the database 812.

Similarly, it can be seen parts 801, 802 & 803 in the example are each shown surrounded by dotted lines. This sets out equivalently the geometric constraints according to those part specified. In this way, harmonisation in respect of geometry and scale. The area within are 814′ shows parts scaled to geometrically conform thereto within area 801′. Schematically this illustrates the parts 803, 808 & 801′ cooperate with desired geometric tolerances as described. The components in area 814 are shown in geometric correspondence to each other indicating each component is within geometric tolerance in the manner described. In the described preferred embodiment, it can be seen FIG. 8 can be used to schematically illustrate parts, assemblies, master-assemblies and building specifications in a hierarchical manner.

The 1^{st} instance catalogue 812 thus contains the three parts as noted previously namely 801, 802 and 803. The desired assembly 814 uses two of these parts 801 and 803 and requires the third part 808. Accordingly, the HPDMI system enables the designer 111 to create the new part 808 which is present in the 2^{nd} instance catalogue 813. The part 801 in the 1^{st} instance catalogue 812 is also, for the sake of the example, present in the 2^{nd} instance catalogue 813 as depicted by a dashed arrow 804. The part 802 in the 1^{st} instance catalogue 812 is also, for the sake of the example, present in the 2^{nd} instance catalogue 813 as depicted by a dashed arrow 805. The part 803 in the 1^{st} instance catalogue 812 is also present in the 2^{nd} instance catalogue 813 as depicted by a dashed arrow 806.

The pre-harmonised part 801 in the 2^{nd} instance catalogue 813 is harmonised by the designer 111 using the HPDMI system as required by the desired assembly 814 by scaling it up in size as depicted by a dashed arrow 807 so that it assumes the shape depicted by 801′. The pre-harmonised part 803 in the 2^{nd} instance catalogue 813 is harmonised by the designer 111 using the HPDMI system by scaling it down in size, as depicted by a dashed arrow 810, to assume the size depicted by 803′. The harmonised part 801′ is assembled together with the new part 808 and the harmonised part 803′, as depicted by respective dashed arrows 808, 809, and 811 to form the desired harmonised assembly 814.

FIGS. 2A and 2B depict a general-purpose computer system 200, upon which the various arrangements described can be practiced.

As seen in FIG. 2A, the computer system 200 includes: the computer server module 113; input devices such as a keyboard 202, a mouse pointer device 203, a scanner 226, a camera 227, and a microphone 280; and output devices including a printer 215, a display device 214 and loudspeakers 217. An external Modulator-Demodulator (Modem) transceiver device 216 may be used by the computer module 113 for communicating, for example, with the remote terminals 106, 109, 115, 122, the remote server(s) not shown executing the 3^{rd} party software applications 146, and remote databases 110, 290 over a communications network 220 via a connection 221. The communications network 220 may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220.

Although the following description is directed primarily to the server module 113, the remote terminals 109, 106, 115 and 122 and the remote server(s) (not shown) executing the 3^{rd} party software application(s) operate in a similar manner and have similar structural and functional attributes.

The computer server module 113 typically includes at least one processor unit 205, and a memory unit 206. For example, the memory unit 206 may have semiconductor random access memory (RAM) and semiconductor read only memory (ROM). The computer module 113 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. In some implementations, the modem 216 may be incorporated within the computer module 113, for example within the interface 208. The computer module 113 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet circuit card, a Bluetooth® wireless arrangement or an IEEE 802.11 wireless arrangement; however, numerous other types of interfaces may be practiced for the interface 211.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 200.

The components 205 to 213 of the computer module 113 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun Sparcstations, Apple Mac™ or like computer systems.

The HPDMI method may be implemented using the computer system 200 wherein the processes of FIGS. 3-9, to be described, may be implemented as one or more software application programs 130, and one or more APIs 146, executable within the computer system 200. In particular, the steps of the HPDMI method are effected by instructions 231 (see FIG. 2B) in the software 130 that are carried out within the computer system 200. The software instructions 231 may be formed as one or more code modules, each for performing one or more particular tasks, and functionally distributed among the server 113 and the remote terminals 109, 106, 115 and 122. The software may also be divided into two separate parts, in which a first part and the corresponding code modules performs the HPDMI methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous HPDMI apparatus.

The software 130 and the APIs 146 are typically stored in the HDD 210 or the memory 206. The software is loaded into the computer system 200 from a computer readable medium, and executed by the computer system 200. Thus, for example, the software 130 and the APIs 146 may be stored on an optically readable disk storage medium (e.g., CD-ROM) 225 that is read by the optical disk drive 212. A computer readable medium having such software or computer program recorded on it is a computer program product. The use of the computer program product in the computer system 200 preferably effects an HPDMI apparatus.

In some instances, the application programs 130 and the APIs 146 may be supplied to the user encoded on one or more CD-ROMs 225 and read via the corresponding drive 212, or alternatively may be read by the user from the networks 220 or 222. Still further, the software can also be loaded into the computer system 200 from other computer readable media.

Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 113. Examples of transitory or non-tangible computer readable transmission media that may also participate in the provision of software, application programs, instructions and/or data to the computer module 113 include radio or infra-red transmission channels as well as a network connection to another computer or networked device, and the Internet or Intranets including e-mail transmissions and information recorded on Websites and the like.

The second part of the application programs 130 and the APIs 146 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the HDD 209 and semiconductor memory 206) that can be accessed by the computer module 113 in FIG. 2A.

When the computer module 113 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 113 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 113 has sufficient memory in which to execute without colliding with memory allocated to another process. Furthermore, the different types of memory available in the system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 130 includes a sequence of instructions 231 that may include conditional branch and loop instructions. The program 130 may also include data 232 which is used in execution of the program 130. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The disclosed HPDMI arrangements use input variables 254, which are stored in the memory 234 in corresponding memory locations 255, 256, 257. The HPDMI arrangements produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 130. Each fetch, decode, and execute cycle comprises:
a fetch operation, which fetches or reads an instruction 231 from a memory location 228, 229, 230;
a decode operation in which the control unit 239 determines which instruction has been fetched; and
an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the processes of FIGS. 3-9 is associated with one or more segments of the program 130 and is performed by the register section 244, 245, 247, the ALU 240, and the control unit 239 in the processor 205 working together to perform the fetch, decode, and execute cycles for every instruction in the instruction set for the noted segments of the program 130.

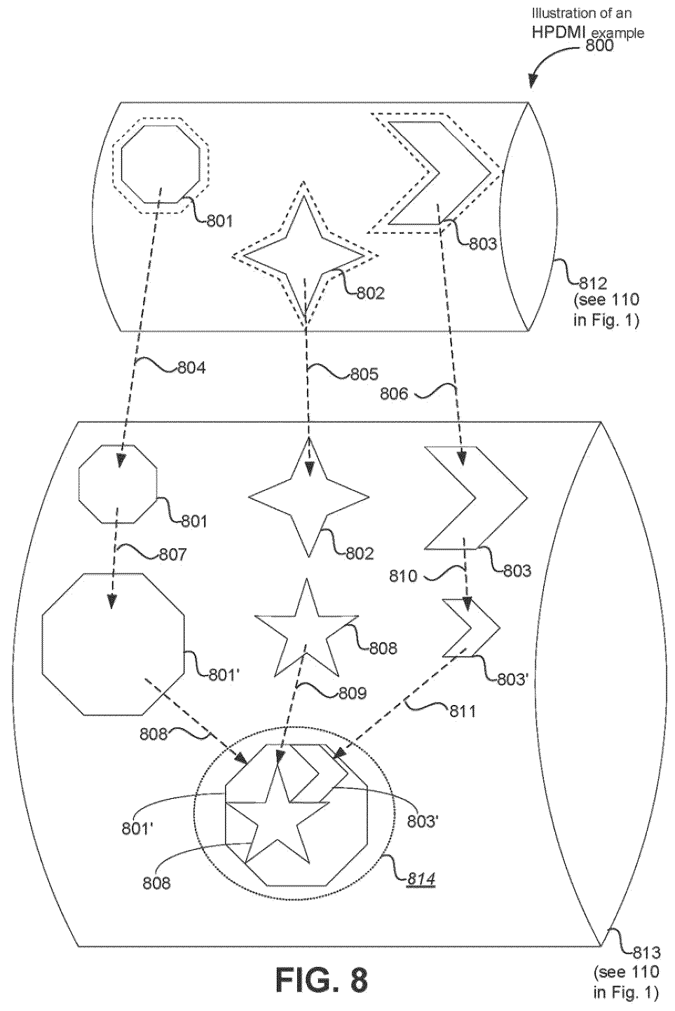

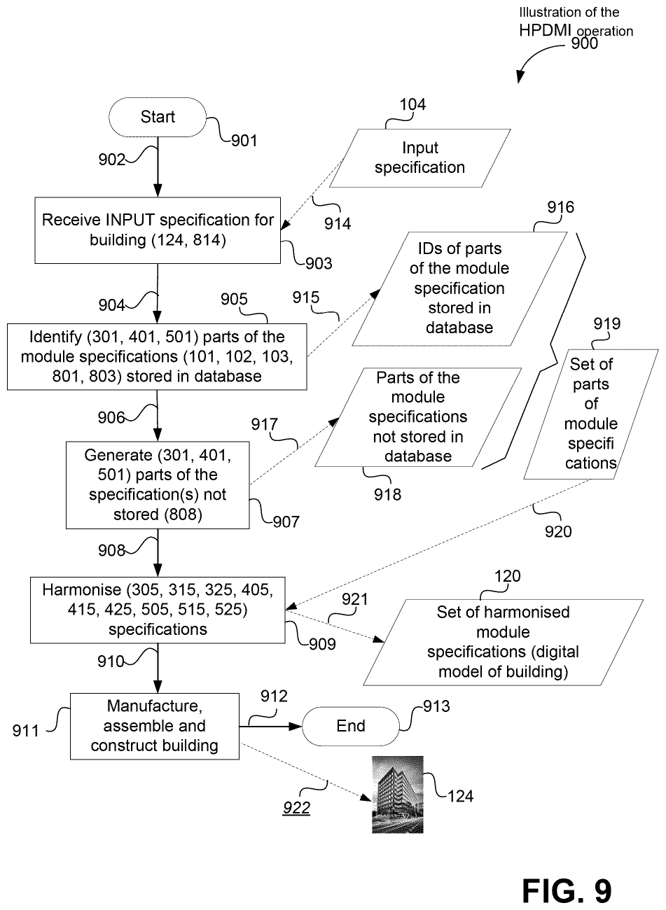

FIG. 9 is a flow chart of an example process 900 for performing the HPDMI process. The process 900 commences at a start step 901. The process then follows an arrow 902 to a step 903. The step 903, performed by the processor 205 executing the software program 130 receives, as depicted by a dashed arrow 914, the input specification 104 (see FIG. 1). The process then follows an arrow 904 to a step 905. The step 905, performed by the processor 205 executing the software program 130 enables the design team 111 to identify, as described hereinafter in more detail with reference to steps 301, 401 and 501 in FIGS. 3, 4 and 5 respectively, which parts of the module specifications 101, 102 and 103 (eg see 801, 803 in FIG. 8) are stored in the database 110. The step 905 outputs, as depicted by a dashed arrow 915, information 916 identifying the parts of the required module specifications 101, 102 and 103 which are stored in the database 110. The information 916 identifies what are referred to as first pre-harmonised module specifications for the parts of the module specifications which are present in the database 110.

The process 900 then follows an arrow 906 to a step 907. The step 907, performed by the processor 205 executing the software program 130, enables the design team to access the 3^{rd} party software applications 146 such as Rhinoceros 3D, for example, in order to generate, as described hereinafter in more detail with reference to steps 301, 401 and 501 in FIGS. 3, 4 and 5 respectively, the parts (see 808 in FIG. 8 for example) of the specifications 101, 102, 103 which are not stored in the database 110. The step 907 outputs, as depicted by a dashed arrow 917, the desired afore-mentioned parts of the specifications 918 which are not stored in the database. The specifications 918 which are not stored in the database 110 are referred to as second pre-harmonised module specifications for the parts of the module specifications which not are present in the database 110. It can be seen in FIG. 9 that these parts not previously stored in the catalogue are added thereto with predetermined attributes.

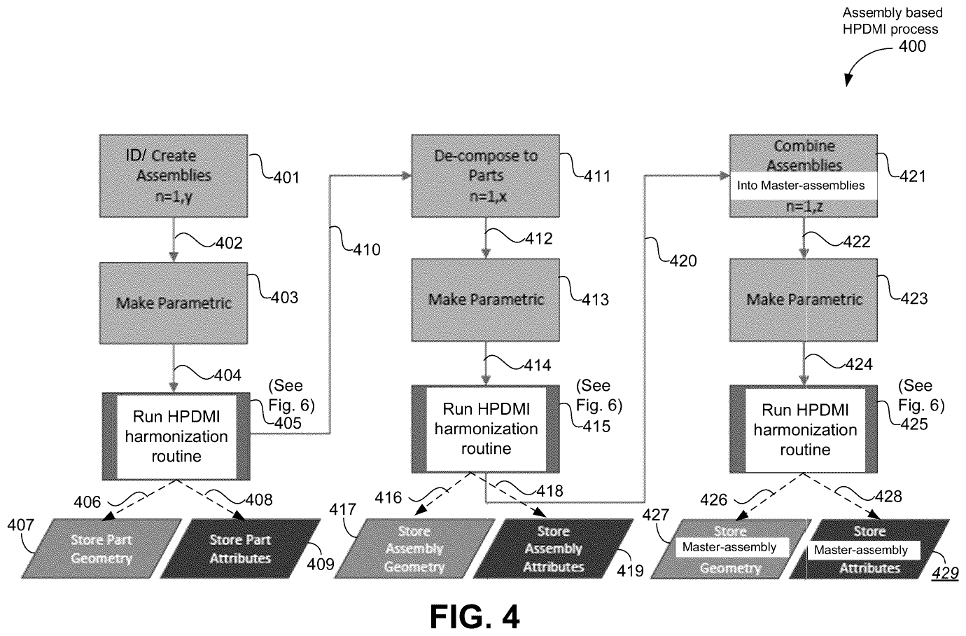

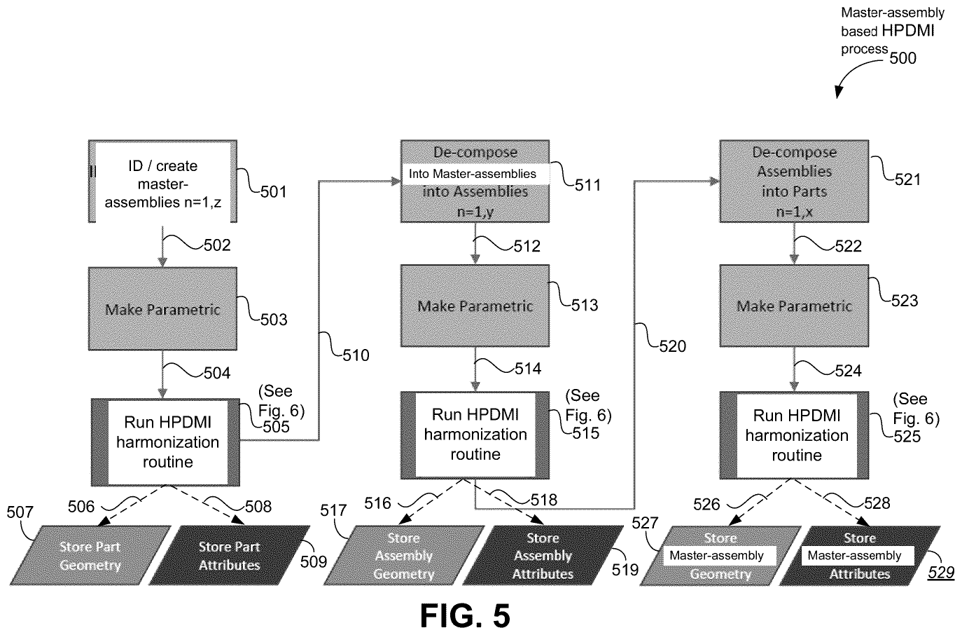

The first pre-harmonised module specifications (identified by the information 916) plus the second pre-harmonised module specifications 918 form a set 919 of pre-harmonised module specifications. The set 919 of pre-harmonised module specifications are provided, as depicted by a dashed arrow 920, to a step 909. The step 909, performed by the processor 205 executing the software program 130, in conjunction with the design team accessing the 3^{rd} party software applications 146, harmonises, as described hereinafter in more detail with reference to steps 305, 315, 325 in FIG. 3, 405, 415, 425 in FIG. 4, and steps 505, 515, 525 in FIG. 5, the set 919 of pre-harmonised module specifications which are required. The step 909 outputs, as depicted by a dashed arrow 921, a set of harmonised module specifications which constitute the output module specifications 120 (also referred to as a digital twin of the building 124) and it is harmonised module specifications 120 that are used from which to manufacture the parts from. It can be seen step 909 is carried out using the method described in respect of FIG. 6.

The process 900 then follows an arrow 910 from the step 909 to a step 911. In the step 911 the manufacture, assembly and construction team 125 manufactures the harmonised parts, harmonised assemblies and harmonised master-assemblies according to the output module specification 120, assembles them as required and constructs, as depicted by a dashed arrow 922, the building 124. The process 900 then follows an arrow 912 to a termination stop 913 and the process terminates.

FIG. 7 shows a flow chart for an example process 700 for performing the HPDMI process using the processes of FIGS. 3, 4 and 5. The process 700 commences with a start step 701 and then follows an arrow 702 to a step 703. The step 703, performed by the processor 205 executing the software program 130, received the input specifications 104 (see FIG. 1). The process then follows an arrow 704 from the step 703 to a decision step 705.

As described with reference to FIG. 1, the building 124 is typically constructed using some parts, as specified by the parts specification 103, some assemblies, as specified by the assembly specification 102, and some master-assemblies, as specified by the master-assembly specification 101.

The step 705, performed by the processor 205 executing the software program 130 enables the design team 111 to access the relevant 3^{rd} party software applications 146 to thereby determine if the input specification 104 being considered is at least partially parts-based, namely whether the input specification 104 contains parts specified by the parts specification 100. If the step 705 returns a FALSE value, then the process follows a NO arrow 706 from the step 705 to a decision step 707. The step 707 performed by the processor 205 executing the software program 130 enables the design team 111 to access the relevant 3^{rd} party software applications 146 to thereby determine if the input specification being considered is at least partially assembly-based, namely whether the input specification 104 contains assemblies specified by the assembly specification 102. If the step 707 returns a FALSE value, then the process follows a NO arrow 708 from the step 707 to a step 709.

The step 709 performed by the processor 205 executing the software program 130 enables the design team 111 to access the relevant 3^{rd} party software applications 146 to thereby determine if the input specification being considered is at least partially master assembly-based, namely whether the input specification 104 contains master-assemblies specified by the master-assembly specification 101. If the step 709 returns a TRUE value, then the process follows an arrow 710 to a step 711 (described hereinafter in more detail with reference to a process 500 in FIG. 5). The step 711, performed by the processor 205 executing the software program 130 enables the design team 111 to access the relevant 3^{rd} party software applications 146 to thereby identify generate and store harmonised master-assembly, assembly and part specifications as well as harmonised master-assembly, assembly and part geometry parameters and attributes in the catalogue 110 (as described in more detail with reference to FIG. 5). The process then follows an arrow 712 to a step 713. If the step 709 returns a FALSE value, then an ERROR message is generated.

The step 713, performed by the processor 205 executing the software program 130, receives the harmonised HPDMI outputs 120 from the processes 300, 400 and 500 in FIGS. 3, 4 and 5 respectively, and from the catalogue 110. The process then follows an arrow 714 from the step 713 to a step 911 (see FIG. 9). In the step 911 the manufacture, assembly and construction team 125 manufactures the harmonised parts, harmonised assemblies and harmonised master-assemblies according to the output module specification 120, assembles them as required and constructs the building 124. The process then follows an arrow 716 to an end step 717 at which point the process terminates.

Returning to the step 705, if the step returns a TRUE value, the process follows a YES arrow 718 from the step 705 to a step 719 (described hereinafter in more detail with reference to 300 in FIG. 3). The step 719, performed by the processor 205 executing the software program 130 enables the design team 111 to access the relevant 3^{rd} party software applications 146 to thereby identify, generate and store harmonised part, assembly and master-assembly specifications as well as harmonised part, assembly and master-assembly geometry parameters and attributes in the catalogue 110 (as described in more detail with reference to FIG. 3). The process then follows an arrow 720 to the step 713.

Returning to the step 707, if the step returns a TRUE value, the process follows a YES arrow 721 from the step 707 to a step 722 (described hereinafter in more detail with reference to 400 in FIG. 4). The step 722, performed by the processor 205 executing the software program 130 enables the design team 111 to access the relevant 3^{rd} party software applications 146 to thereby identify, generate and store harmonised assembly, part and master-assembly specifications as well as harmonised assembly, part and master-assembly geometry parameters and attributes in the catalogue 110 (as described in more detail with reference to FIG. 4). The process then follows an arrow 723 to the step 713.

FIGS. 3, 4 and 5 are respective example flow charts for a part-based HPDMI harmonisation process 300, an assembly-based HPDMI harmonisation process 400, and a master assembly-based HPDMI harmonisation process 500. FIGS. 3, 4 and 5 refer to parts, assemblies and master-assemblies for brevity of description, however the processes actually operate on part specifications, assembly specifications, and master-assembly specifications, as described below. As previously noted, the present specification considers input specifications 104 which specify the building using one or more of (A) a specification 147 for the building, (B) specifications 103 for parts, (C) specifications 102 for assemblies, (D) and specifications 101 for master-assemblies, namely four hierarchical levels. FIGS. 3, 4 and 5 depict three levels, namely parts, assemblies and master-assemblies. However, since as previously noted other numbers of hierarchical levels can also be used in the disclosed HPDMI arrangements.

FIG. 3 is an example flow chart for a part-based HPDMI harmonisation process 300. This relates to the use-case in which the input specification 104 comprises at least some part specifications 103 which specify the pre-harmonisation parts to be used in constructing the building 124.

The process 300 commences with a step 301, performed by the processor 205 executing the software program 130 which, given the input specification 104, enables the design team 111 to access 3^{rd} party software applications such as Rhinoceros 3D, for example, to thereby (A) identify the pre-harmonisation part specifications specified by the input part specification 103 if these are present (see FIG. 1), (B) identify those of the required part specifications which are pre-stored in the catalogue 110, and (C) create those of the required part specifications which are not stored in the catalogue 110. The total of the pre-stored part specifications and the created part specifications are designated as part specifications n=1,x where x is the total number of parts required by the input part specification 103.

The process 300 then follows an arrow 302 to a step 303, performed by the processor 205 executing the software program 130, which enables the design team 111 to access 3^{rd} party software applications such as Rhinoceros 3D, for example, to thereby make the aforementioned part specifications n=1,x parametric. The term “make parametric” means to specify the part dimensions in terms of parameters, Thus, for example, the part 129 in FIG. 1 is defined by variables t, l, h, d, s, THETA and w. One way of making the specification of the plate parametric is to define the aforementioned variables in terms of each other e.g. t=0.1l, h=0/3l, d=0.05l, s=0.6l, w=0.2l, and THETA=l/h radians. The process then follows an arrow 304 to a step 305, performed by the processor 205 executing the software program 130, described hereinafter in more detail with reference to FIG. 6, which enables the design team 111 to access the relevant 3^{rd} party software applications to thereby harmonise the part specifications n=1,x both with respect to their respective geometric parameters and their respective attributes. The step 305 outputs, as depicted by an arrow 310, harmonised part specifications n=1,x and also outputs, as depicted by dashed arrows 306 and 308, harmonised part geometric parameters 307 and harmonised part attributes 309 and stores these in the catalogue 110.

The process 300 then follows the arrow 310 to a step 311, performed by the processor 205 executing the software program 130 to enable the design team 111 to access the Tekla software applications, for example, to thereby combine at least some of the aforementioned harmonised part specifications n=1,x into assembly specifications n=1,y where y is the total number of assembly specifications required by the input assembly specification 102. The process 300 then follows an arrow 312 to a step 313, performed by the processor 205 executing the software program 130 to enable the design team 111 to access the Rhino3D and Grasshopper software applications, for example, to thereby make the aforementioned assembly specifications n=1,y parametric.

The process then follows an arrow 314 to a step 315, performed by the processor 205 executing the software program 130, described hereinafter in more detail with reference to FIG. 6, which enables the design team 111 to access the relevant 3^{rd} party software applications to thereby harmonise (a) the assembly specifications n=1,y both with respect to their respective geometric parameters and their respective attributes and (b) the part specifications not combined into the assembly specifications n=1,y in the step 311. The step 315 outputs, as depicted by an arrow 320, the harmonised assembly specifications n=1,y and also outputs, as depicted by dashed arrows 316 and 318, harmonised assembly geometric parameters 317 and harmonised assembly attributes 319 for the aforementioned assemblies. The step 315 also updates in the catalogue 110 the part geometric parameters and the part attributes for the those of the part specifications n=1,x which were not combined into the assembly specifications n=1,y in the step 311.

The process 300 then follows the arrow 320 to a step 321, performed by the processor 205 executing the software program 130 to enable the design team 111 to access the Tekla software applications, for example, to thereby combine at least some of the aforementioned harmonised assembly specifications n=1,y into master-assembly specifications n=1,z where z is the total number of master-assemblies required by the input master-assembly specification 101. The process 300 then follows an arrow 322 to a step 323, performed by the processor 205 executing the software program 130 to enable the design team 111 to access the Rhino3D and Grasshopper software applications, for example, to thereby make parametric the aforementioned master-assembly specifications n=1,z.

The process then follows an arrow 324 to a step 325, performed by the processor 205 executing the software program 130, described hereinafter in more detail with reference to FIG. 6, which enables the design team 111 to access the relevant 3^{rd} party software applications to thereby harmonise (a) the master-assembly specifications n=1,z both with respect to their respective geometric parameters and their respective attributes, (b) the assembly specifications which were not combined into the master-assembly specifications n=1,z in the step 321, and (c) the part specifications which were not combined into the assembly specifications n=1,y in the step 311. The step 325 outputs the harmonised master-assembly specifications n=1,z and also outputs, as depicted by dashed arrows 326 and 388, harmonised master-assembly geometric parameters 327 and harmonised master-assembly attributes 329 for the aforementioned harmonised master-assembly specifications and stores these in the catalogue 110. The step 325 also updates in the catalogue 110 (a) the part geometric parameters and the part attributes for the those of the part specifications n=1,x which were not combined into the assembly specifications n=1,y in the step 311, and (b) the assembly geometric parameters and the assembly attributes for the those of the assembly specifications n=1,y which were not combined into the master-assembly specifications n=1,z in the step 321.

FIG. 4 is an example flow chart for an assembly-based HPDMI harmonisation process 400. This relates to the use-case in which the input specification 104 comprises at least some assembly specifications 102 which specify the pre-harmonisation assemblies to be used in constructing the building 124.

The process commences with a step 401, performed by the processor 205 executing the software program 130 which, given the input assembly specification 104, enables the design team 111 to access 3^{rd} party software applications such as Rhinoceros 3D, for example, to thereby (A) identify the pre-harmonisation assembly specifications required by the input assembly specification 102 if these are present (see FIG. 1), (B) identify those of the required pre-harmonisation assembly specifications which are pre-stored in the catalogue 110, and (C) create those of the required pre-harmonisation assembly specifications which are not stored in the catalogue 110. The total of the pre-stored pre-harmonisation assembly specifications and the created pre-harmonisation assemblies are designated as pre-harmonisation assembly specifications n=1,y where y is the total number of assemblies required by the input assemblies specification 102.

The process 400 then follows an arrow 402 to a step 403, performed by the processor 205 executing the software program 130 to thereby enable the design team 110 to access the Rhino3D and Grasshopper software applications, for example, to thereby make the aforementioned pre-harmonisation assembly specifications n=1,y parametric. The process then follows an arrow 404 to a step 405, performed by the processor 205 executing the software program 130, described hereinafter in more detail with reference to FIG. 6, which enables the design team 111 to access the relevant 3^{rd} party software applications to thereby harmonise the pre-harmonisation assembly specifications n=1,y both with respect to their respective geometric parameters and their respective attributes. The step 405 outputs, as depicted by an arrow 410, harmonised assembly specifications n=1,y and also outputs, as depicted by dashed arrows 406 and 408, harmonised part geometric parameters 407 and harmonised part attributes 409 and stores these in the catalogue 110.

The process 400 then follows the arrow 410 to a step 411, performed by the processor 205 executing the software program 130 to enable the design team 111 to access the Tekla software applications, for example, to thereby decompose the aforementioned harmonised assembly specifications n=1,y into part specifications n=1,x where x is the total number of parts required by the input part specification 103. The process 400 then follows an arrow 412 to a step 413, performed by the processor 205 executing the software program 130 to enable the design team 111 to access the Rhino3D and Grasshopper software applications, for example, to thereby make the aforementioned part specifications n=1,x parametric.

The process then follows an arrow 414 to a step 415, performed by the processor 205 executing the software program 130, described hereinafter in more detail with reference to FIG. 6, which enables the design team 111 to access the relevant 3^{rd} party software applications to thereby harmonise the part specifications n=1,x both with respect to their respective geometric parameters and their respective attributes. The step 415 outputs, as depicted by an arrow 420, the harmonised part specifications n=1,x and also outputs, as depicted by dashed arrows 416 and 418, harmonised assembly geometric parameters 417 and harmonised assembly attributes 419 for the aforementioned parts and stores these in the catalogue 110.

The process 400 then follows the arrow 420 to a step 421, performed by the processor 205 executing the software program 130 to enable the design team 111 to access the Tekla software applications, for example, to thereby combine the aforementioned harmonised assembly specifications n=1,y into master-assembly specifications n=1,z where z is the total number of master-assemblies required by the input master-assembly specification 101. The process 400 then follows an arrow 422 to a step 423, performed by the processor 205 executing the software program 130 to enable the design team 111 to access the Rhino3D and Grasshopper software applications, for example, to thereby make parametric the aforementioned master-assembly specifications n=1,z.

The process then follows an arrow 424 to a step 425, performed by the processor 205 executing the software program 130, described hereinafter in more detail with reference to FIG. 6, which enables the design team 111 to access the relevant 3^{rd} party software applications to thereby harmonise the master-assembly specifications n=1,z both with respect to their respective geometric parameters and their respective attributes. The step 425 outputs harmonised master-assembly specifications n=1,z and also outputs, as depicted by dashed arrows 426 and 428, harmonised master-assembly geometric parameters 427 and harmonised master-assembly attributes 429 for the aforementioned master-assemblies and stores these in the catalogue 110.

FIG. 5 is an example flow chart for a master-assembly-based HPDMI harmonisation process 500. This relates to the use-case in which the input specification 104 comprises at least some master-assembly specifications 101 which specify the pre-harmonisation master-assemblies to be used in constructing the building 124.

The process commences with a step 501, performed by the processor 205 executing the software program 130 which, given the input specification 104, enables the design team 111 to access 3^{rd} party software applications such as Rhinoceros 3D, for example, to thereby (A) identify pre-harmonisation master-assembly specifications required by the input master-assembly specification 101 if these are present (see FIG. 1), (B) identify those of the required pre-harmonisation master-assembly specifications which are pre-stored in the catalogue 110, and (C) create those of the required pre-harmonisation master-assembly specifications which are not stored in the catalogue 110. The total of the pre-stored pre-harmonisation master-assembly specifications and the created pre-harmonisation master-assembly specifications are designated as pre-harmonisation master-assembly specifications n=1,z where z is the total number of master-assemblies required by the input master-assembly specification 101.

The process 500 then follows an arrow 502 to a step 503, performed by the processor 205 executing the software program 130, which enables the design team 111 to access 3^{rd} party software applications such as Rhinoceros 3D, for example, to thereby make the aforementioned pre-harmonisation master-assembly specifications n=1,z parametric. The process then follows an arrow 504 to a step 505, performed by the processor 205 executing the software program 130, described hereinafter in more detail with reference to FIG. 6, which enables the design team 111 to access the relevant 3^{rd} party software applications to thereby harmonise the pre-harmonisation master-assembly specifications n=1,z both with respect to their respective geometric parameters and their respective attributes. The step 505 outputs, as depicted by an arrow 510, harmonised master-assembly specifications n=1,z and also outputs, as depicted by dashed arrows 506 and 508, harmonised part geometric parameters 507 and harmonised part attributes 509 and stores these in the catalogue 110.

The process 500 then follows the arrow 510 to a step 511, performed by the processor 205 executing the software program 130 to enable the design team 111 to access the Tekla software applications, for example, to thereby decompose the aforementioned harmonised master-assembly specifications n=1,z into assembly specifications n=1,y where y is the total number of assemblies required by the input assembly specification 102. The process 500 then follows an arrow 512 to a step 513, performed by the processor 205 executing the software program 130 to enable the design team 111 to access the Rhino3D and Grasshopper software applications, for example, to thereby make the aforementioned assembly specifications n=1,y parametric.

The process then follows an arrow 514 to a step 515, performed by the processor 205 executing the software program 130, described hereinafter in more detail with reference to FIG. 6, which enables the design team 111 to access the relevant 3^{rd} party software applications to thereby harmonise the assembly specifications n=1,y both with respect to their respective geometric parameters and their respective attributes. The step 515 outputs, as depicted by an arrow 520, harmonised assembly specifications n=1,y and also outputs, as depicted by dashed arrows 516 and 518, harmonised assembly geometric parameters 517 and harmonised assembly attributes 519 for the aforementioned assemblies and stores these in the catalogue 110.

The process 500 then follows the arrow 520 to a step 521, performed by the processor 205 executing the software program 130 to enable the design team 111 to access the Tekla software applications, for example, to thereby decompose the aforementioned harmonised assembly specifications n=1,y into part specifications n=1,x where x is the total number of parts required by the input part specification 103. The process 500 then follows an arrow 522 to a step 523, performed by the processor 205 executing the software program 130 to enable the design team 111 to access the Rhino3D and Grasshopper software applications, for example, to thereby make parametric the aforementioned part specifications n=1,x.

The process then follows an arrow 524 to a step 525, performed by the processor 205 executing the software program 130, described hereinafter in more detail with reference to FIG. 6, which enables the design team 111 to access the relevant 3^{rd} party software applications to thereby harmonise the part specifications n=1,x both with respect to their respective geometric parameters and their respective attributes. The step 525 outputs harmonised part specifications n=1,x and also outputs, as depicted by dashed arrows 526 and 528, harmonised master-assembly geometric parameters 527 and harmonised master-assembly attributes 529 for the aforementioned harmonised parts and stores these in the catalogue 110.

FIG. 6 shows an example flow chart for an HPDMI geometric parameter and attribute harmonisation process 600 used in the steps 305, 315 and 325 in FIG. 3, the steps 405, 415 and 425 in FIG. 4, and the steps 505, 515 and 525 in FIG. 5.

When used in FIG. 3 the process 600 receives as an input at a start step 601 pre-harmonised part specifications n=1,x when used in the step 305, pre-harmonised assembly specifications n=1,y when used in the step 315, and pre-harmonised master-assembly specifications n=1,z when used in the step 325. When used in FIG. 4 the process 600 receives as an input at the start step 601 pre-harmonised assembly specifications n=1,y when used in the step 405, pre-harmonised part specifications n=1,x when used in the step 415, and pre-harmonised master-assembly specifications n=1,z when used in the step 425. When used in FIG. 5 the process 600 receives as an input at the start step 601 pre-harmonised master-assembly specifications n=1,z when used in the step 505, pre-harmonised assembly specifications n=1,y when used in the step 515, and pre-harmonised part specifications n=1,x when used in the step 525.

The process 600 commences with a start step 601 as noted above and follows an arrow 602 to a decision step 603. When processing each pre-harmonised part specification n=1,x the step 603, performed by the processor 205 executing the software program 130 to enable the design team 111 to access the Navisworks software application, for example, is a null step because since each part is a single module there cannot be a clash, and so the step 603 returns a FALSE value and the process 600 follows a NO arrow 604 from the step 603 to a step 605.

When processing each pre-harmonised assembly specification n=1,y the step 603, performed by the processor 205 executing the software program 130, enables the design team 111 to access the Navisworks software application, for example, to thereby determine if any of the pre-harmonised parts making up the pre-harmonised assembly clash (a clash occurs if any of the parts making up the assembly occupy some of the same space as any other of the constituent parts of the assembly). If this is the case then the process follows a YES arrow 601 from the step 603 to a step 616. The step 616, performed by the processor 205 executing the software program 130, enables the design team 111 to adjust the geometric parameters of one or more of the clashing parts to eliminate the clash, after which the process follows an arrow 617 back to the step 603. If, on the other hand, the step 603 returns a false value, indicating that no clash has been detected, then the process 600 follows and NO arrow 604 from the step 603 to a step 605.

When processing each pre-harmonised master-assembly specification n=1,z the step 603, performed by the processor 205 executing the software program 130, enables the design team 111 to access the Navisworks software application, for example, to thereby determine if any of the pre-harmonised assemblies or pre-harmonised parts making up the pre-harmonised master-assembly clash. If this is the case then the process follows a YES arrow 601 from the step 603 to a step 616. The step 616, performed by the processor 205 executing the software program 130, enables the design team 111 to adjust the geometric parameters of one or more of the clashing parts and/or clashing assemblies to eliminate the clash, after which the process follows an arrow 617 back to the step 603. If, on the other hand, the step 603 returns a false value, indicating that no clash has been detected, then the process 600 follows and NO arrow 604 from the step 603 to a step 605.

The step 605, performed by the processor 205 executing the software program 130, enables the design team 111 to access the relevant 3^{rd} party software applications 146 to thereby determine if, and which, analysis is required for the part, the assembly, or the master-assembly being considered. It is noted that the part, the assembly, or the master-assembly being considered in the step 605 have already been processed by the step 603 for clash detection, and accordingly the part, the assembly, or the master-assembly being considered in the step 605 are referred to respectively as a post clash-detection part, a post clash-detection assembly, or a post clash-detection master-assembly. Thus, for example, the input specification 104 may specify an interior wall which is not intended to be load bearing, either vertically or laterally. The input specification in this case would specify the wall based on a set of rules such as distance between steel studs because of sheet widths, and no (structural) analysis is required. However, if the design team determines that the wall is subject to internal pressure differentials, then the strength of the wall needs to be analysed for code compliance and thus (structural) analysis is required. It is noted that structural analysis is only one example, and other types of analysis including electrical, hydraulic, code compliance and the like can be considered in the disclosed HPDMI arrangements.

If the step 605 returns a TRUE value, indicating that analysis is required, then the process follows a YES arrow 606 from the step 605 to a step 607. The step 607, performed by the processor 205 executing the software program 130, enables the design team 111 to access the appropriate attribute catalogue (such as the OneSteel product catalogue and other such catalogues for structural attributes, for example), to thereby assign and/or adjust attributes of the module (ie part, assembly or master-assembly) in question Thus, for example, in the case of the interior wall referred to above the relevant attributes can include elastic modulus and yield strength of steel.

The process 600 then follows an arrow 608 from the step 607 to a step 609. The step 609, performed by the processor 205 executing the software program 130, enables the design team 111 to access the Tekla software application, for example, to thereby perform the analysis process identified in the step 605. Importantly the analysis performed in the disclosed HPDMI arrangements maintains the geometry and attributes in separate sections of the database 110 throughout the course of the analysis, i.e. going into the analysis step 609 and coming out of the step 609. The process 600 then follows an arrow 610 from the step 609 to a decision step 611.

The step 611, performed by the processor 205 executing the software program 130, enables the design team 111 to access the Capterra software, for example, to thereby determine if the results of the analysis are acceptable. For example, if a mechanical structure is being considered for mechanical performance a national code compliance check is typically applied. If the step 611 returns a FALSE value, then the process 600 follows a NO arrow 612 from the step 611 to a step 613. The step 613, performed by the processor 205 executing the software program 130, enables the design team 111 to access the relevant 3^{rd} party software applications 146 to thereby determine whether attributes or geometric parameters of the post clash-detection part, the post clash-detection assembly, or the post clash-detection master-assembly in question need to be adjusted. If the step 613 determines that an attribute needs to be adjusted, then the process 600 follows an ATTRIBUTES arrow 614 from the step 613 back to the step 607. Thus, for example, if the design team 111 determines at the step 613 that a cable guide does not conform to the relevant code, the design team 111 may, in the step 607, adjust the yield strength of the material from grade 250 to grade 350 material. If, on the other hand, the step 613 determines that geometric parameters need to be adjusted, then the process 600 follows a GEOMETRY arrow 615 from the step 613 to the step 616.

The step 616, performed by the processor 205 executing the software program 130, enables the design team 111 to access the relevant 3^{rd} party software applications 146 to thereby adjust geometric parameters as required. Thus, for example, if a cable guide is found not to be not strong enough for code compliance, the design team 111 can adjust the geometry by making the backing plate thicker by adjusting the geometric thickness parameter). The process 600 then follows an arrow 617 from the step 616 back to the step 603. Returning to the step 605, if the step determines that analysis is not required then the process 600 follows a NO arrow 620 from the step 605 to an end step 619. Returning to the step 611, if the step 611 determines that the results of the analysis are acceptable, then the process 600 follows a YES arrow 618 from the step 611 to the end step 619.

FIG. 6 sets out a description of a generalised example for harmonisation elements based on geometry (at 603) and subsequently upon attributes (at 607) whether this be parts or an assembly, for example. In the case of FIG. 6, by way of illustrative example, the assembly or component under the process described can include say a window (not illustrated) being harmonised with the process. At 603, when considering a geometric clash a ‘No’ response if provided if the window will fit within a predefined frame or opening. If the window will not fit, step 616 adjusts the window geometry accordingly or can cause specifications to be changed to re-define the window frame or opening geometry, for example

Once the window is correctly sized and the right geometry, an analysis of the window is made against predefined attributes required for the window such as materials formed from or structural/load bearing requirements so that modification is made to the window attributes which are then tested against the geometric requirements before providing the output at 616.

In the converse, and referring particularly to FIG. 6 at step 607, it will be appreciated that in some cases, the geometry may be caused to be adjusted (step 613) when attributes are changed such that when implemented the geometry will clash with the specification. Here, since the attributes are necessary, the geometry will be adjusted accordingly as a consequence.

In the example of the window above, it may be that the selected window will be required to have its attributes adjusted (step 607) such as to provide structural or load bearing characteristics where physically larger (or even smaller) window elements are required (eg, frames or mounting elements). In such a case, the change in attributes may result in the need for a corresponding change to the geometry (step 613 to step 616) which is then re-harmonised through step 617.

It can be seen that whilst either geometry or attributes may be changed during harmonisation, a combination of both geometric and attribute changes may be required as set out in FIG. 6. This can be a compounding process whereby geometry and attributes may be changed multiple times each during the harmonisation process of FIG. 6. Most advantageously, this allows changes to conform to the required specifications.

FIG. 10 shows an example 1000 of a part-based segment depicting a data structure of the database 110. It can be seen that a particular part 1003 is a specification record relating to a cable guide having geometric parameters which are stored in the database in a geometric parameter section 1001 and attributes which are stored separately in an attribute section 1002.

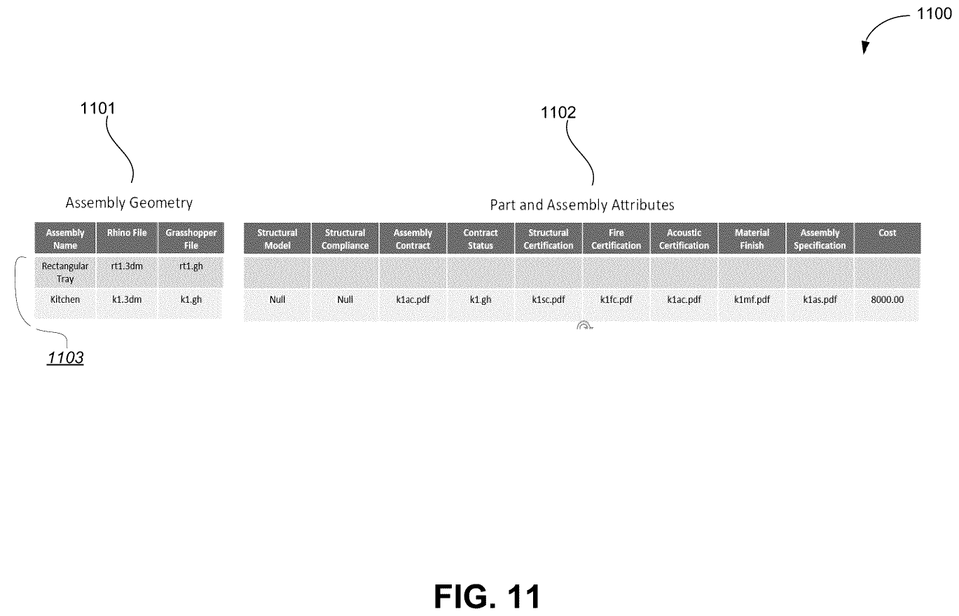

FIG. 11 shows an example 1100 of an assembly-based segment of the database 110. It can be seen that a particular assembly 1102 relates to a rectangular tray having geometric parameters which are stored in the database in a geometric parameter section 1101 and attributes which are stored separately in an attribute section 1102.

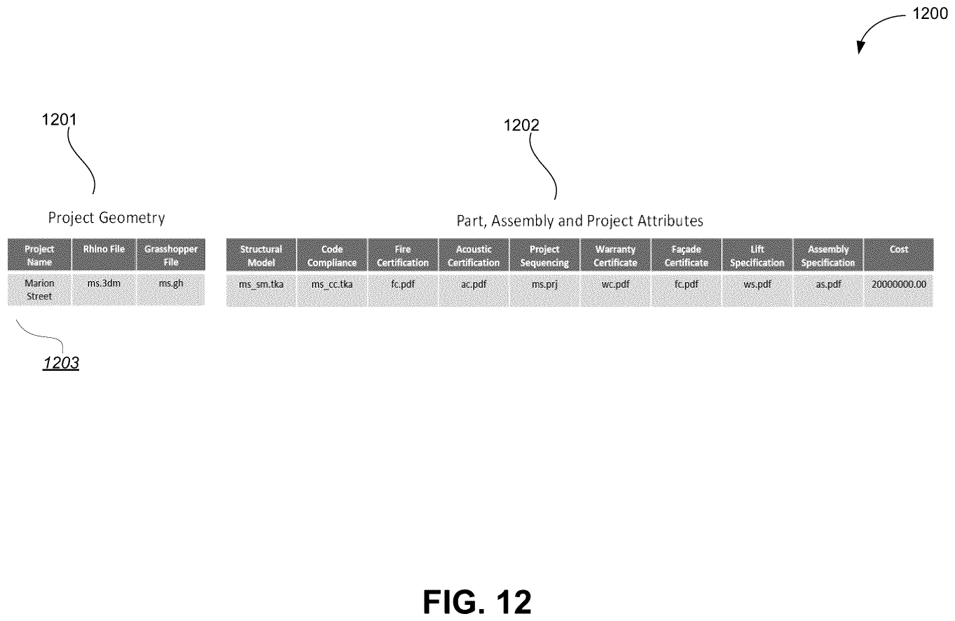

FIG. 12 shows an example 1200 of a master-assembly-based segment of the database 110. It can be seen that a particular master-assembly 1203 relates to a Marion Street master-assembly having geometric parameters which are stored in the database in a geometric parameter section 1201 and attributes which are stored separately in an attribute section 1202.

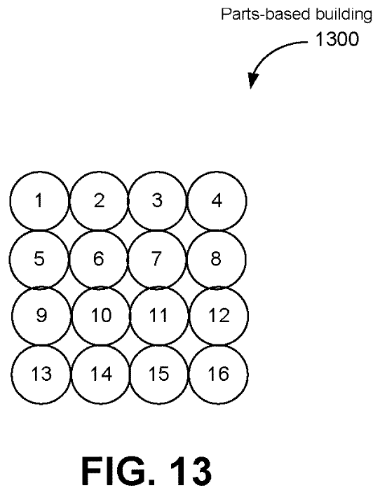

FIG. 13 depicts a 2-dimensional representation of a building 1300 made from a regular rectangular array of 16 parts (reference numerals 1301-1316). In one example the disclosed HPDMI process is applied to successive sets of touching parts in a raster-scan pattern 1301, 1302, 1303, 1304, 1305, 1306 and so on. The part 1301 is touching both the part 1302 and the part 1305 and accordingly, starting with the part 1301 a 1^{st} harmonisation pass involves the parts 1301, 1302 and 1305, as represented by the following relationship:

P1=1301/1302/1305

where: 1301 refers to the part 1301 which is unconstrained by any previous harmonisation passes, 1302 refers to the part 1302 which is unconstrained by any previous harmonisation passes, and 1305 refers to the part 1305 which is unconstrained by any previous harmonisation passes.

The part 1302 is touching the parts 1301, 1303, and 1306 and accordingly, proceeding with the part 1302 a 2^{nd} harmonisation pass involves the parts 1302, 1303 and 1306, as represented by the following relationship:

P2=1302¹³⁰¹/1303/1306¹³⁰⁵

where: 1302¹³⁰¹ refers to the part 1302 which is constrained by a previous harmonisation pass including the part 1301, 1303 refers to the part 1303 which is unconstrained by any previous harmonisation passes, and 1306¹³⁰⁵ refers to the part 1306 which is constrained by a previous harmonisation pass including the part 1305.

The part 1303 is touching the parts 1302, 1304, and 1307 and accordingly, proceeding with the part 1303 a 3^{rd} harmonisation pass involves the parts 1303, 1304 and 1307, as represented by the following relationship:

P3=1303¹³⁰²/1304/1307¹³⁰⁶

where: 1303¹³⁰² refers to the part 1303 which is constrained by a previous harmonisation pass including the part 1302, 1304 refers to the part 1304 which is unconstrained by any previous harmonisation passes, and 1307¹³⁰⁶ refers to the part 1307 which is constrained by a previous harmonisation pass including the part 1306

As described in respect of the above preferred embodiments, there is provided a method, system and apparatus that minimises both materials and efficiency of building construction by virtue of use of the harmonizing process throughout. It will be appreciated, however, that in other preferred embodiment the harmonization process can be employed to create multistory buildings, for example.

Here, the processes is applied firstly to the structural frame, chassis or backbone of the building. Subsequently, it is applied to all the other parts and assemblies that make up the entire building. The backbone geometry, being accurately generated as described in the above embodiments, then becomes the known geometry in 3d space that all the other parts and assemblies are produced to fit to which advantageously improves building efficiency. An important part of the harmonization process is to perform the analysis (in this case structural) and ensure conformity of performance and optimization by altering either the geometry or the attributes.

It will be seen that the other parts and assemblies which in multi-story typically includes facades, bathrooms, internal walls, windows, air conditioning systems, stairs, lifts and elevators amongst many others. Each of these parts or assemblies are themselves created or decomposed using the process described in the above embodiments, and are fitted with some predetermined tolerance to the backbone (or frame).

Another preferred embodiment using the process of the above described embodiments includes a data entre which may also be a multistory building, but which the data racks are the first or overarching geometry critical to the building. In such a case the harmonization process is applied to the data racks, and this geometry is then used to fix all other parts in 3D space and they are drawn to conform to it. For instance the backbone geometry and applied harmonisation would be required to conform to the data rack geometry, not the other way around, and the application of the harmonization to all other parts and assembles is to fit to the data racks.

It will be appreciated that a further embodiment includes productions of a hydro PowerStation, when the key geometry requirement is the size, location and performance if large inflow pipes. In this case the geometry would be governed by fluid flow analysis and structural performance and the harmonisation process be applied to this critical geometry and all other parts and assemblies fitted to it. Similarly, a further embodiment may create an electrical substation, where, in a similar fashion the size and performance of the transformers dictate the critical geometry and the electrical analysis and attributes determine the optimization of this process.

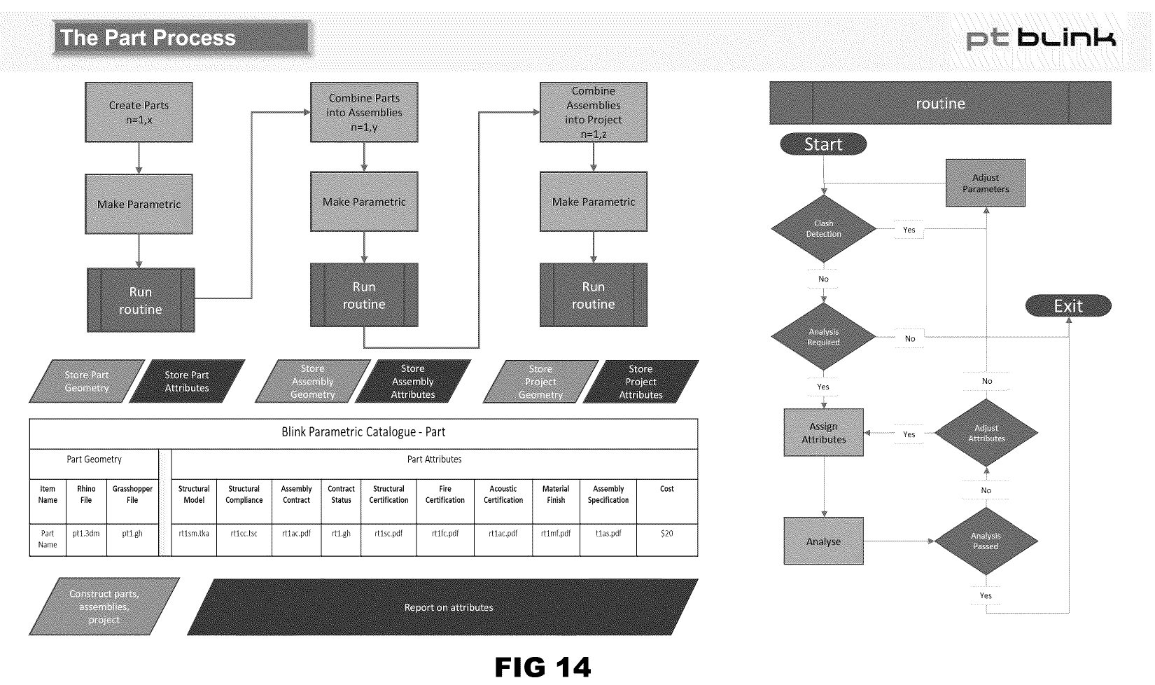

As can be seen, it will be appreciated that the above described preferred embodiments of the harmonisation process is that it is the geometric requirements and constraints from which all harmonisation occurs. The fundamental importance of the geometric requirements is briefly described below with reference to FIGS. 14 to 20 illustrating the harmonisation process.

FIG. 14 is similar to FIGS. 3 & 10 in the embodiment above and show the Part harmonisation sub-process and illustration of the parts based database. The righthand side of FIG. 14 show process steps in a flow chart form in the harmonisation.

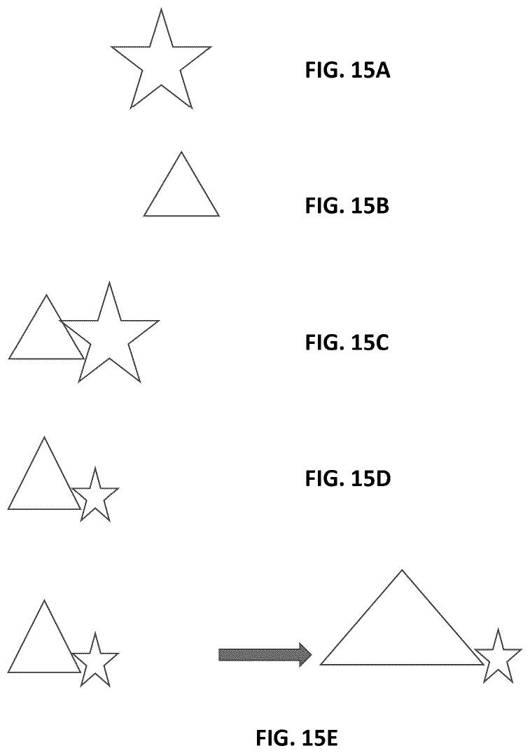

By continuing the visualization of the HPDMI process set described above with reference to FIG. 8, FIGS. 15A-E show this in a stepwise manner. In the initial step, a designated Part 1 is selected as a master part and is shown in FIG. 15A as a 5-pointed star for illustrative purposes but can represent any part. The second part in the process is then selected and defined, shown as a triangle in FIG. 15B.

Employing the harmonisation process of FIG. 14, the second part is harmonised to the first, master part. This is shown in FIG. 15C where the parts are harmonised to form an assembly. It can be seen that this assembly defines its own geometry. That geometry is then used in the HPDMI process that is used to harmonize other assemblies, master assemblies and buildings.

In some embodiments, it will be appreciated that the HPDMI process of FIG. 14 in harmonising the process analysis may be required resulting in a geometrical change to the second (triangle part), for example, it may require increased mechanical strength. This is shown in FIG. 15D in an exaggerated manner.

Similarly, it can be seen that this assembly then defines its own geometry. That geometry can in turn be used harmonize other assemblies, master assemblies and buildings. However, execution of the harmonization routine may require analysis that may result in a geometrical change to part 1 (star), when part 2 is designated as the master part (again, it might not be strong enough for example).

The result if this is shown illustratively in FIG. 15E and it will be appreciated that this assembly defines its own geometry which can then be used to harmonize other assemblies, master assemblies and buildings. The two solutions (ie depending on the designated part 1) are separate and unique and would therefore create entirely different assemblies, master assemblies and buildings. This advantageously allows for the opportunity for optimization against any desired criteria subsequently. This would be the case when creating a tray from parts and assemblies.

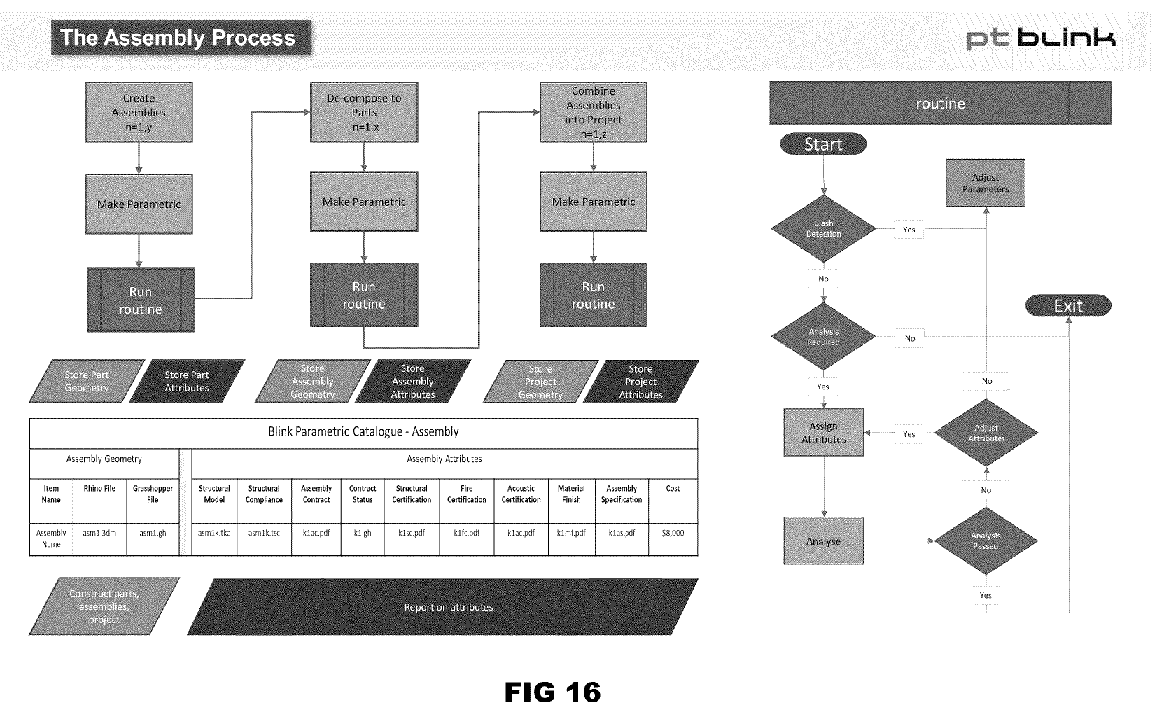

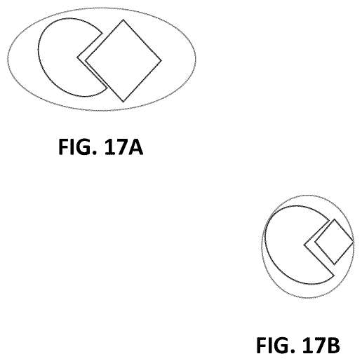

The same HPDMI process for harmonisation is used for the assembly process of the assemblies and parts. This is shown in FIG. 16 is a similar manner to the parts process of FIG. 14. An example assembly created is schematically illustrated in FIG. 17A. This assembly has its own unique harmonized geometry that must be contained within the ellipse.

The assembly can be broken down into its constituent parts. One can be the ellipse to which all must conform and is labeled the master part, and the HPDMI harmonisation process executed. This may change the assembly, that can then be combined to make master assemblies and projects. This is shown illustratively in FIG. 17B where the geometry of the constituents are modified to maximally conform thereby improving efficiency in the building process and it will be appreciated that the new assembly of FIG. 17B can then be combined into master assemblies and projects.

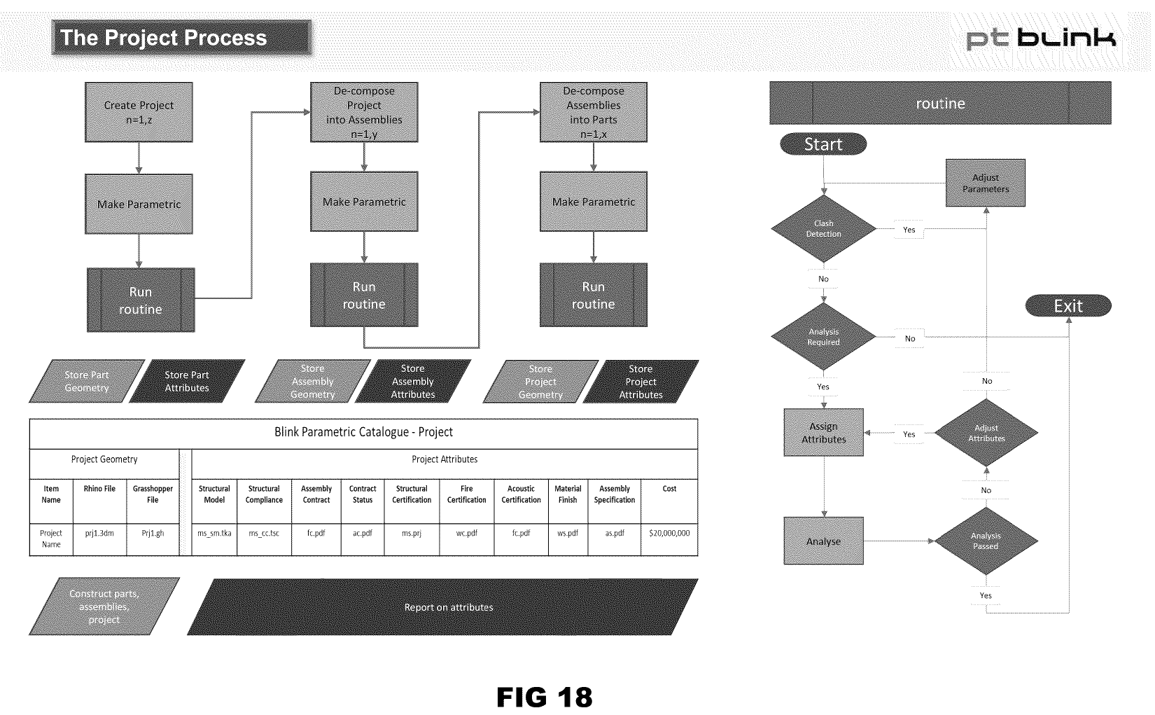

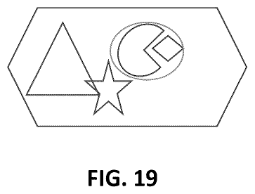

In a manner similarly to that described with reference to FIGS. 4 & 5, for example, whereby projects are decomposed into assemblies and decompose into parts. This is shown in FIG. 18 and in the same manner as the part or assembly processes above. In reference to FIG. 19, a project is schematically illustrated with the same parts and assemblies above contained with the irregular hexagon shape.

Commencing with projects, it can be seen that they can be broken down into assemblies. The assemblies can be labeled as master assemblies and the HPDMI harmonisation process executed. It is noted the assemblies can swap the master label and the harmonisation process re-executed which, as described above, leaves further optimization and harmonisation available at a later stage. Similarly, assemblies can be broken down into parts and parts can likewise be labeled master parts, and the harmonisation process executed.

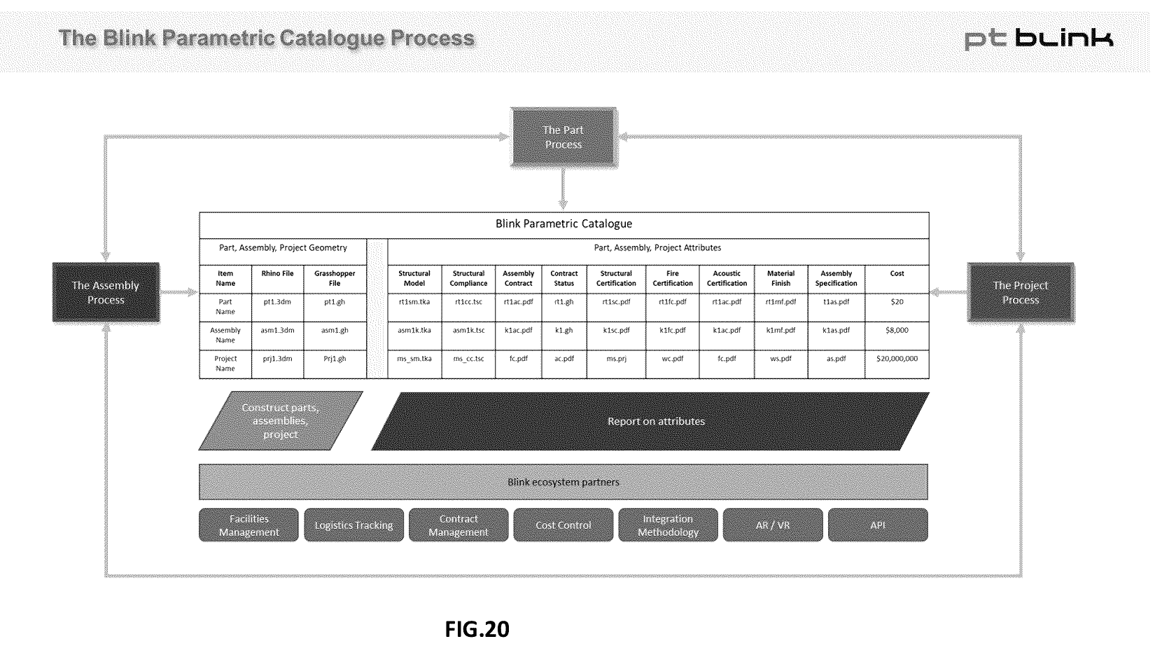

FIG. 20 shows in flow chart for the method of creating a parametric catalogue of parts, assemblies and project geometries and attributes. This commences with defining the master assemblies or master parts at any level of the process and, importantly, in combination. The process and constructions produced by the HPDMI harmonisation process can advantageously be accurately and reliably defined leading to significant construction efficiencies based on geometries and scales.

### INDUSTRIAL APPLICABILITY

The arrangements described are applicable to the computer and data processing industries and particularly as they apply to the construction industry.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

APPENDIX A

| Name | Used for | Details |
|---|---|---|
| Rhinoceros | 3D computer graphics and | developed by Robert |
| (typically | computer-aided design | McNeel & Associates |
| abbreviated Rhino, | (CAD) application software | |
| or Rhino3D) | | |
| Grasshopper 3D | a visual programming | developed by Robert |
| | language and environment | McNeel & Associates |
| | that runs within the | |
| | Rhinoceros 3D computer- | |
| | aided design (CAD) | |
| | application | |
| Tekla | software product family | produced by Trimble, |
| | that consists of programs | a publicly listed US- |
| | for analysis and design, | based technology |
| | detailing and project | company |
| | communication | |
| Navisworks | Used in construction | |
| | industries to complement | |
| | 3D design packages such | |
| | as Autodesk Revit | |
| OneSteel product | Catalogue containing | Maintained by |
| catalogue | attributes for steel parts, | Australian Steel |
| | assemblies and master- | Institute (ASI) |
| | assemblies | |
| Trimble | Building Construction | The NASDAQ Stock |
| | (BIM Application) | Exchange, TRMB |
| Capterra | Code Enforcement software | Acquired by Gartner in |
| | assists government | 2015 |
| | organizations in enforcing | |
| | compliance with municipal | |
| | code requirements. | |

1. A computer implemented method of harmonised parameter based design of a building in facilitating construction of the building, the method comprising:
receiving an input specification for the building, said input specification specifying pre-harmonisation modules required to provide the building, said pre-harmonisation modules defined by respective pre-harmonisation module specifications comprising respective geometric parameters and respective attributes;
identifying which of the pre-harmonisation module specifications are stored in an electronically accessible database, said identified pre-harmonisation module specifications being referred to as first pre-harmonisation module specifications having associated geometric parameters and attributes which are stored in separate sections of the database;
harmonising the module specifications in the first pre-harmonisation module specifications to form a set of parametrised and harmonised module specifications which specify harmonised modules which (a) substantially do not clash when they are used to provide the building, and (b) when assembled to form the building satisfy attribute criteria specified in the input specification; and
facilitating construction of the building using the harmonised module specification.

2. The method according to claim 1 further comprising, prior to harmonizing the module specifications in the first pre-harmonisation module specifications:
generating pre-harmonisation module specifications which are not stored in the database, said generated module specifications being referred to as second pre-harmonisation module specifications;
wherein the first pre-harmonisation module specifications together with the second pre-harmonisation module specifications form a set of pre-harmonisation module specifications; and
wherein harmonizing the module specifications in the first pre-harmonisation module specifications comprises harmonising the set of pre-harmonisation module specifications comprising the first pre-harmonisation specification modules together with the second pre-harmonisation module specifications.

3. The method according to claim 1, wherein the pre-harmonisation modules required to provide the building comprise one or more of part specifications, assembly specifications, master-assembly specifications, and building specifications, and wherein harmonising the module specifications to form the set of harmonised module specifications comprises:
determining geometric parameters for the one or more of the part specifications, assembly specifications, master-assembly specifications, and building specifications;
determining attributes for at least some of the one or more of the part specifications, assembly specifications, master-assembly specifications, and building specifications; and
storing the geometric parameters and the attributes in the electronically accessible database, wherein the geometric parameters and the attributes for each of the one or more of the part specifications, assembly specifications, master-assembly specifications, and building specifications are stored in separate sections of the database.

4. The method according to claim 1, wherein harmonizing the module specifications in the first pre-harmonisation module specifications comprises:
determining if analysis of one or more of a post clash-detection part, a post clash-detection assembly, or post clash-detection master-assembly specifications in question is required in order to establish if the attributes of the post clash-detection part, the post clash-detection assembly, or the post clash-detection master-assembly specification in question satisfy the attribute criteria specified in the input specification;
if analysis of said one or more of the post clash-detection part, the post clash-detection assembly, or the post clash-detection master-assembly specifications in question is required:
assigning corresponding attributes to the one or more of the post clash-detection part, the post clash-detection assembly, or the post clash-detection master-assembly specifications in question;
performing corresponding one or more analysis processes, maintaining geometry and attributes of said one or more of the post clash-detection part, the post clash-detection assembly, or the post clash-detection master-assembly specifications in question in separate sections of the database throughout a course of the analysis;
determining if the attributes of the post clash-detection part, the post clash-detection assembly, or the post clash-detection master-assembly specifications in question satisfy the attribute criteria specified in the input specification;
if the attributes of the post clash-detection part, the post clash-detection assembly, or the post clash-detection master-assembly specifications in question do not satisfy the attribute criteria specified in the input specification, determining if the assigned corresponding attributes or the geometric parameters of the post clash-detection part, the post clash-detection assembly, or the post clash-detection master-assembly specifications in question need to be adjusted;
if the geometric parameters are to be adjusted, adjusting the geometric parameters so that the attributes of the post clash-detection part, the post clash-detection assembly, or the post clash-detection master-assembly specifications in question satisfy the attribute criteria specified in the input specification; and
if the attributes are to be adjusted, adjusting the attributes of the post clash-detection part, the post clash-detection assembly, or the post clash-detection master-assembly specifications in question so that the attributes of the first pre-harmonisation module specifications satisfy the attribute criteria specified in the input specification.

5. A method according to claim 2 wherein the first and second pre-harmonisation module specifications are stored as validated tokens in a blockchain network.

6. An apparatus for facilitating construction of a building, the apparatus comprising:
one or more computer processors;
one or more tangible non-transitory computer readable storage media storing a computer executable software program for directing the one or more computer processors to execute a method comprising:
receiving an input specification for the building, said input specification specifying pre-harmonisation modules required to provide the building, said pre-harmonisation modules defined by respective pre-harmonisation module specifications comprising respective geometric parameters and respective attributes;
identifying which of the pre-harmonisation module specifications are stored in an electronically accessible database, said identified pre-harmonisation module specifications being referred to as first pre-harmonisation module specifications having associated geometric parameters and attributes which are stored in separate sections of the database;
harmonising the module specifications in the first pre-harmonisation module specifications to form a set of parametrised and harmonised module specifications which specify harmonised modules which (a) substantially do not clash when they are used to provide the building, and (b) when assembled to form the building satisfy attribute criteria specified in the input specification; and
providing the building using the harmonised module specification.

7. One or more tangible non-transitory computer readable storage media storing a computer executable software program for directing one or more computer processors to execute a method comprising:
receiving an input specification for the building, said input specification specifying pre-harmonisation modules required to provide the building, said pre-harmonisation modules defined by respective pre-harmonisation module specifications comprising respective geometric parameters and respective attributes;
identifying which of the pre-harmonisation module specifications are stored in an electronically accessible database, said identified pre-harmonisation module specifications being referred to as first pre-harmonisation module specifications having associated geometric parameters and attributes which are stored in separate sections of the database;
harmonising the module specifications in the first pre-harmonisation module specifications to form a set of parametrised and harmonised module specifications which specify harmonised modules which (a) substantially do not clash when they are used to provide the building, and (b) when assembled to form the building satisfy attribute criteria specified in the input specification; and
facilitating construction of the building using the harmonised module specification.

8. A data structure storing specification records each record specifying a pre-harmonisation module used for facilitating construction of a building, wherein:
each record specifies one of a part specification, an assembly specification, a master-assembly specification, and a building specification;
each record comprises respective geometric parameters and respective attributes for the stored specification;
memory allocated to each record comprises a section for storing the geometric parameters of the record and a section for storing attributes for the record; and
the geometric parameters and the attributes for each record are stored in the separate sections of the database to thereby reduce the computation time required for processing one or more specification records in the data structure to provide the building.

9. A computer implemented method of harmonised parameter based design of a building in facilitating construction of the building, the method comprising:
receiving an input specification for the building, said input specification specifying pre-harmonisation modules required to provide the building, said pre-harmonisation modules defined by respective pre-harmonisation module specifications comprising respective geometric parameters and respective attributes;
identifying which of the pre-harmonisation module specifications are stored in an electronically accessible database, said identified pre-harmonisation module specifications being referred to as first pre-harmonisation module specifications having associated geometric parameters and attributes which are stored in separate sections of the database;
harmonising the module specifications in the first pre-harmonisation module specifications to form a set of parametrised and harmonised module specifications which specify harmonised modules which (a) substantially do not clash when they are used to provide the building, and (b) when assembled to form the building satisfy attribute criteria specified in the input specification;
facilitating construction of the building using the harmonised module specification; and
wherein prior to harmonizing the module specifications in the first Dre-harmonisation module specifications, the method comprises:
generating pre-harmonisation module specifications which are not stored in the database, said generated module specifications being referred to as second pre-harmonisation module specifications;
wherein the first pre-harmonisation module specifications together with the second pre-harmonisation module specifications form a set of pre-harmonisation module specifications; and
wherein harmonizing the module specifications in the first Dre-harmonisation module specifications comprises harmonising the set of pre-harmonisation module specifications comprising the first pre-harmonisation specification modules together with the second pre-harmonisation module specifications.

10. A computer implemented method of harmonised parameter based design of a building in facilitating construction of the building, the method comprising:
receiving an input specification for the building, said input specification specifying pre-harmonisation modules required to provide the building, said pre-harmonisation modules defined by respective pre-harmonisation module specifications comprising respective geometric parameters and respective attributes;
identifying which of the pre-harmonisation module specifications are stored in an electronically accessible database, said identified pre-harmonisation module specifications being referred to as first pre-harmonisation module specifications having associated geometric parameters and attributes which are stored in separate sections of the database;
harmonising the module specifications in the first pre-harmonisation module specifications to form a set of parametrised and harmonised module specifications which specify harmonised modules which (a) substantially do not clash when they are used to provide the building, and (b) when assembled to form the building satisfy attribute criteria specified in the input specification;
facilitating construction of the building using the harmonised module specification;
wherein prior to harmonising the module specifications in the first Dre-harmonisation module specifications, the method comprises:
generating pre-harmonisation module specifications which are not stored in the database, said generated module specifications being referred to as second pre-harmonisation module specifications;
wherein the first pre-harmonisation module specifications together with the second pre-harmonisation module specifications form a set of pre-harmonisation module specifications; and
wherein harmonising the module specifications in the first Dre-harmonisation module specifications comprises harmonising the set of pre-harmonisation module specifications comprising the first pre-harmonisation specification modules together with the second pre-harmonisation module specifications; and wherein harmonising the module specifications in the first pre-harmonisation module specifications includes:
determining if analysis of one or more of a post clash-detection part, a post clash-detection assembly, or a post clash-detection master-assembly specification in question is required in order to establish if the attributes of the post clash-detection part, the post clash-detection assembly, or the post clash-detection master-assembly specification in question satisfy the attribute criteria specified in the input specification;
if analysis of said one or more of the post clash-detection part, the post clash-detection assembly, or the post clash-detection master-assembly specifications in question is required:
assigning corresponding attributes to the one or more of the post clash-detection part, the post clash-detection assembly, or the post clash-detection master-assembly specifications in question;
performing corresponding one or more analysis processes, maintaining the geometry and attributes of said one or more of the post clash-detection part, the post clash-detection assembly, or the post clash-detection master-assembly specifications in question in separate sections of the database throughout the course of the analysis;
determining if the attributes of the post clash-detection part, the post clash-detection assembly, or the post clash-detection master-assembly specifications in question satisfy the attribute criteria specified in the input specification;
if the attributes of the post clash-detection part, the post clash-detection assembly, or the post clash-detection master-assembly specifications in question do not satisfy the attribute criteria specified in the input specification, determining if the assigned corresponding attributes or the geometric parameters of the post clash-detection part, the post clash-detection assembly, or the post clash-detection master-assembly specifications in question need to be adjusted;
if the geometric parameters are to be adjusted, adjusting the geometric parameters so that the attributes of the post clash-detection part, the post clash-detection assembly, or the post clash-detection master-assembly specifications in question satisfy the attribute criteria specified in the input specification; and
if the attributes are to be adjusted, adjusting the attributes of the post clash-detection part, the post clash-detection assembly, or the post clash-detection master-assembly specifications in question so that the attributes of the first pre-harmonisation module specifications satisfy the attribute criteria specified in the input specification.
